(19) United States
(12) Patent Application Publication
(10) Pub. No.: US 2021/0205819 A1
(43) Pub. Date: Jul. 8, 2021

(54) CIRCULATING MILL, APPLICATION METHOD THEREOF, AND PRODUCT PROCESSED BY CIRCULATING MILL

(71) Applicants: Yunnan Qidan Pharmaceutical Co.,Ltd., Wenshan (CN); KUNMING TEKANG TECHNOLOGY CO.,LTD, KUNMING (CN); ZHEJIANG YUNJIE TECHNOLOGY CO.,LTD, Wenzhou (CN)

(72) Inventors: Ping JIA, Kunming (CN); Xiuming CUI, Wenzhou (CN); Yawen ZENG, Wenzhou (CN); Yongxin SHE, Wenzhou (CN)

(21) Appl. No.: 17/207,691

(22) Filed: Mar. 21, 2021

Related U.S. Application Data
(63) Continuation of application No. PCT/CN2019/106794, filed on Sep. 19, 2019.

(30) Foreign Application Priority Data
Sep. 21, 2018 (CN) 201811110206.4

(51) Int. Cl. B02C 13/288; B02C 13/282; B02C 21/00; B02C 23/28; F26B 3/084; F26B 21/02; F26B 25/22

(52) U.S. Cl. CPC B02C 13/288; B02C 13/282; B02C 21/00; F26B 25/22; F26B 3/084; F26B 21/02; B02C 23/28

(57) ABSTRACT

A circulating mill, comprising primary mills (47, 57) and secondary mills (49, 61), and first and second inner circulation pipes (48, 58, 52, 64). The first inner circulation pipes (48, 58) are connected to air outlets of the primary mills (47, 57) and inner circulation pipe interfaces (3, 11), and the second inner circulation pipes (52, 64) are connected to air outlets of the secondary mills (49, 61) and the inner circulation pipe interfaces (3, 11); the inner circulation pipe interfaces (3, 11) are located on a housing (1) of the primary mills (47, 57) or the secondary mills (49, 61), or located on feed pipes (56, 60) of which one end is connected to the air inlet of the housing (1); a kinetic energy recovery device is mounted in the feed pipes (56, 60), and the kinetic energy recovery device is connected to an impeller in the housing (1).

### CROSS-REFERENCE TO RELATED APPLICATIONS

This application is a continuation of International Application No. PCT/CN2019/106794 with a filling date of Sep. 19, 2019, designating the United states, now pending, and further claims to the benefit of priority from Chinese Application No.201811110206.4 with a filing date of Sep. 21, 2018. The content of the aforementioned applications, including any intervening amendments thereto, are incorporated herein by reference.

### TECHNICAL FIELD

The present invention relates to a circulating mill for drying and grinding, and belongs to the fields of circulating fluidized bed technologies, Chinese herbal medicine processing technologies, agricultural product processing technologies, drying and grinding technologies, new material preparation technologies, and energy-saving and environmental protection technologies.

### BACKGROUND

The invention patent 2018111102064 “CIRCULATING MILL, APPLICATION METHOD THEREOF, AND PRODUCT PROCESSED BY CIRCULATING MILL” discloses a circulating mill. The circulating mill can quickly make fresh products, liquid and other high-moisture and high-viscosity materials into dry powder at normal temperature and recover water from the materials in the form of liquid. It can also be used for ultrafine grinding of minerals. It has the characteristics of low energy consumption, large output, and good product quality. However, it has at least three following shortcomings. Firstly, a kinetic energy recovery blade structure for kinetic energy recovery of high-speed fluidized materials is unreasonable. A kinetic energy recovery blade is disposed in a mill impeller, high-speed fluidized materials at an outlet of a primary mill is used to impact the kinetic energy recovery blade in an impeller of a secondary mill to assist in driving the impeller of the secondary mill to rotate, high-speed fluidized materials at an outlet of the secondary mill is also used to impact the kinetic energy recovery blade in an impeller of the primary mill to assist in driving the impeller of the primary mill to rotate, so as to implement recovery and utilization of the kinetic energy of the high-speed fluidized materials to reduce the energy consumption of the circulation of the fluidized materials in the circulating mill. The structure of the kinetic energy recovery blade makes the fluidized materials have no flow channel to flow out in time after impacting the kinetic energy recovery blade, which hinders the continuous and effective impact of subsequent fluidized materials on the kinetic energy recovery blade, and the kinetic energy recovery rate of the fluidized materials is not high. In addition, the kinetic energy recovery blade with a simple structure cannot form a pressure difference between windward and leeward sides of the blade, and the pressure difference can also be used as an auxiliary force to drive the impeller to rotate in theory. Secondly, a heat exchanger of an operation medium supply branch relies only on a low-temperature air flow from a condenser to cool high-temperature and high-humidity tail gas discharged from a bag dust collector, heat required by the cooling air is only sensible heat, and the cooling of the tail gas not only gives out sensible heat, but also has the latent heat of water liquefaction. Due to the insufficient cooling supply, the temperature and moisture content of the air flow into the condenser cannot be reduced to be low enough, and the condenser needs to consume more energy so as to reduce the moisture content of the air flow to meet process requirements of the circulating mill. Returning in the circulating mill process refers to the return of the powder in the circulating mill main engine by an outer circulation channel. Returning improves the fluidization state of the high-humidity and high-viscosity materials and is of great significance to the circulating mill process. Thirdly, in the invention patent 2018111102064, only powder discharged by a cyclone dust collector becomes returned materials. For liquid and high-moisture and high-viscosity materials with moisture content over 95%, the effect is far from the target due to an insufficient return quantity. Reference may be made to Chinese invention patents 2018111102064, 2017111181038, 2015110139212, 2014108408080, and 2010101628876 for more technical backgrounds of the application.

### SUMMARY OF THE INVENTION

A first objective of the present invention is to continuously improve the circulating mill described in the invention patent 2018111102064 to improve economy and reliability thereof, and a second objective of the present invention is to provide application methods of a circulating mill and products processed by a circulating mill.

A technical measure employed to achieve the first objective of the present invention is as follows: a first circulating mill is composed of a housing, an impeller, and a kinetic energy recovery device, the housing is provided with an inner circulation pipe interface near an air inlet, an air flow from the inner circulation pipe interface assists in driving the impeller to rotate by impacting the kinetic energy recovery device, the air inlet on the housing is an inlet of the first circulating mill, and an air outlet on the housing is an outlet of the first circulating mill.

The kinetic energy recovery device of the first circulating mill is implemented in such a way that an air inlet on a front disc expands to expose a blade or an annular window is formed on the front disc to expose the blade, and the air flow from the inner circulation pipe interface assists in driving the impeller to rotate by impacting the exposed blade.

Another technical measure employed to achieve the first objective of the present invention is as follows: a second circulating mill is composed of a housing, an impeller, a kinetic energy recovery device, and a feed pipe, the feed pipe is provided with an inner circulation pipe interface, one end of the feed pipe is connected to an air inlet on the housing, the kinetic energy recovery device is disposed in the feed pipe, an air flow from the inner circulation pipe interface assists in driving the impeller to rotate by impacting the kinetic energy recovery device, the other end of the feed pipe is an inlet of the second circulating mill, and an air outlet on the housing is an outlet of the second circulating mill.

In order to maximize the recovery and utilization of the kinetic energy of fluidized materials, the present invention further provides a third circulating mill, which is composed of a housing, an impeller, a kinetic energy recovery device, and a feed pipe. The feed pipe is provided with an inner circulation pipe interface, one end of the feed pipe is connected to an air inlet on the housing, the kinetic energy recovery device is disposed in the feed pipe, the impeller is driven to rotate by the kinetic energy recovery device impacted by the air flow from the inner circulation interface, the other end of the feed pipe is an inlet of the third circulating mill, and an air outlet on the housing is an outlet of the third circulating mill.

In one implementation, the kinetic energy recovery device of the second or third circulating mill is a kinetic energy recovery blade. The kinetic energy recovery blade is fixed to an impeller shaft or fixed to an impeller shaft elongating along the feed pipe, or one end of the kinetic energy recovery blade is fixed to a rear disc and/or a shaft sleeve and/or an impeller shaft, and the other end is fixed to an impeller shaft elongating along the feed pipe, or the other end is fixed to a connecting plate fixed to an impeller shaft elongating along the feed pipe.

In another implementation, the kinetic energy recovery device of the second or third circulating mill is a kinetic energy recovery impeller. The kinetic energy recovery impeller has many implementations. A first kinetic energy recovery impeller is composed of a kinetic energy recovery blade and an upper ring, one end of the kinetic energy recovery blade is fixed to a shaft sleeve and/or a rear disc, the other end is fixed to the upper ring, and a plurality of kinetic energy recovery blades are distributed circumferentially along the upper ring; and the upper ring is fixed to an impeller shaft elongating along the feed pipe.

In order to improve the rigidity of the kinetic energy recovery impeller of the circulating mill, a reinforcing ring of the kinetic energy recovery blade may be further disposed in a middle part of the kinetic energy recovery impeller. The reinforcing ring is fixed to a middle part of the kinetic energy recovery blade and an impeller shaft elongating along the feed pipe.

For ease of implementation, the kinetic energy recovery impeller is a second kinetic energy recovery impeller, which is composed of a kinetic energy recovery impeller shaft sleeve, a kinetic energy recovery blade, and an upper ring. One end of the kinetic energy recovery blade is fixed to the kinetic energy recovery impeller shaft sleeve, the kinetic energy recovery impeller shaft sleeve is fixed to a shaft sleeve or an impeller shaft, the other end is fixed to the upper ring, the upper ring is fixed to an impeller shaft elongating along the feed pipe, the elongated impeller shaft is provided with bearings fixed to a bracket, and the bracket is fixed to the feed pipe or a base.

In order to reduce the hindrance of the rotation of the kinetic energy recovery impeller on the air flow from the inner circulation pipe interface and increase the torque exerted by the air flow from the inner circulation pipe interface on the kinetic energy recovery impeller, the kinetic energy recovery impeller is a third kinetic energy recovery impeller, which is composed of a kinetic energy recovery impeller shaft sleeve, a kinetic energy recovery impeller shaft, a kinetic energy recovery blade, an upper ring, and a transmission. One end of the kinetic energy recovery blade is fixed to the kinetic energy recovery impeller shaft sleeve, the other end is fixed to the upper ring, the transmission is fixed to a feed pipe and a base, an input shaft of the transmission is the kinetic energy recovery impeller shaft, the kinetic energy recovery impeller shaft sleeve is fixed to the input shaft of the transmission, and an output shaft of the transmission is an impeller shaft or connected therewith; the upper ring is fixed to the input shaft of the transmission, one end of the input shaft of the transmission extending out of the upper ring is provided with bearings fixed to a bracket, and the bracket is fixed to the feed pipe and the base.

The kinetic energy recovery impeller may also be a fourth kinetic energy recovery impeller, which is composed of a kinetic energy recovery impeller shaft sleeve, a lower ring, a kinetic energy recovery blade, and an upper ring. One end of the kinetic energy recovery blade is fixed to the lower ring, the other end is fixed to the upper ring, and the lower ring is fixed to the kinetic energy recovery impeller shaft sleeve.

In order to increase a pressure difference between a windward side and a leeward side of the kinetic energy recovery blade, a cross section of the kinetic energy recovery blade is semicircular or wing-shaped, or the windward side is flat and the leeward side is cambered.

In order to further increase the torque exerted by the air flow from the inner circulation pipe interface on the kinetic energy recovery impeller, the diameter of the second and third kinetic energy recovery impellers of the circulating mill is 0.5 to 4 times that of the impeller.

An important function of the feed pipe is grading, and feed pipes of different structures have different grading capabilities. In order to meet requirements of different processes for grading effects, the feed pipe may be in following forms: a straight pipe with one end connected to an air inlet on the housing and the other end being an inlet of the circulating mill; or a tapered pipe with a small head connected to an air inlet on the housing and a large head being an inlet of the circulating mill; or a tapered pipe with a large head connected to an air inlet on the housing and a small head being an inlet of the circulating mill; or a tapered pipe with a small head connected to an air inlet on the housing and a large head provided with a cover, an opening in the middle of the cover being an inlet of the circulating mill; or a cyclone dust collector, of which an air inlet is an inner circulation pipe interface, an ash discharge port is connected to an air inlet on the housing, and an exhaust outlet is an inlet of the circulating mill; or an uncapped cyclone dust collector, of which an air inlet is an inner circulation pipe interface, an ash discharge port is connected to an air inlet on the housing, and an uncapped end is an inlet of the circulating mill.

On the basis of the technical solution of the circulating mill, the present invention provides six circulating mill main engines.

A first circulating mill main engine is composed of a primary mill, a secondary mill, and an inner circulation pipe, the primary mill and the secondary mill are the first circulating mill, an outlet of the primary mill is connected to an inner circulation pipe interface of the secondary mill through the inner circulation pipe, an outlet of the secondary mill is connected to an inner circulation pipe interface of the primary mill through the inner circulation pipe, an inlet of the primary mill is an inlet of the first circulating mill main engine, and an inlet of the secondary mill is an outlet of the first circulating mill main engine.

A second circulating mill main engine is composed of a primary mill, a secondary mill, and an inner circulation pipe, the primary mill and the secondary mill are the second circulating mill, an outlet of the primary mill is connected to an inner circulation pipe interface of the secondary mill through the inner circulation pipe, an outlet of the secondary mill is connected to an inner circulation pipe interface of the primary mill through the inner circulation pipe, an inlet of the primary mill is an inlet of the second circulating mill main engine, and an inlet of the secondary mill is an outlet of the second circulating mill main engine.

A third circulating mill main engine is the second circulating mill main engine from which the kinetic energy recovery devices in the feed pipes of the primary mill and the secondary mill are removed.

A fourth circulating mill main engine is improved based on the second circulating mill main engine. An outlet on the housing is connected to an inner circulation pipe interface on the feed pipe thereof through the inner circulation pipe, a three-way air inlet is disposed between one end of the feed pipe and the air inlet on the housing, a second opening of the three-way air inlet is an inlet of the fourth circulating mill main engine, and the other end of the feed pipe is an outlet of the fourth circulating mill main engine.

A fifth circulating mill main engine is the fourth circulating mill main engine from which the kinetic energy recovery device in the feed pipe is removed.

A sixth circulating mill main engine is composed of a primary mill, a secondary mill, and an inner circulation pipe, the primary mill is the second circulating mill, the secondary mill is the third circulating mill, an outlet of the primary mill is connected to an inner circulation pipe interface of the secondary mill through the inner circulation pipe, an outlet of the secondary mill is connected to an inner circulation pipe interface of the primary mill through the inner circulation pipe, an inlet of the primary mill is an inlet of the sixth circulating mill main engine, and an inlet of the secondary mill is an outlet of the sixth circulating mill main engine.

In order to straighten the inner circulation pipe and minimize wall hanging in the inner circulation pipe, an axis of the primary mill of the first or second or sixth circulating mill main engine is perpendicular to an axis of the secondary mill.

In order to adjust an air volume of the secondary mill, the inner circulation pipe connected to the outlet of the secondary mill of the first or second or sixth circulating mill main engine is provided with a circulating air volume adjusting device; or the feed pipe of the secondary mill of the second or sixth circulating mill main engine is provided with an air volume adjusting device disposed between the inner circulation pipe interface and one end of the feed pipe; or an air volume adjusting device is disposed between one end of the feed pipe of the fourth circulating mill main engine and the three-way air inlet.

In order to reduce the circulating air flow volume in the circulating mill main engine and reduce the temperature in the engine, a cross-sectional area of the inner circulation pipe connected to the outlet of the secondary mill is less than that of the inner circulation pipe connected to the outlet of the primary mill.

In order to reduce the pressure in the primary mill and reduce the eccentric force generated by the kinetic energy recovery impeller impacted by the air flow from the inner circulation pipe, the housing of the primary mill of the second or sixth circulating mill main engine is provided with 2 or 3 or 4 outlets, and the number of the secondary mill and the number of the inner circulation pipe interface on the feed pipe of the primary mill are the same as the number of the outlet on the housing of the primary mill.

On the basis of the technical solution of the circulating mill main engine, the present invention provides following four technical solutions for circulating mills.

A first circulating mill is composed of the first or second or third or fourth or fifth or sixth circulating mill main engine and a first accessory device, the first accessory device is composed of a dust collector and an outer circulation pipe, an air inlet of the dust collector is connected to the outlet of the circulating mill main engine, and an outlet of the outer circulation pipe is connected to the inlet of the circulating mill main engine.

A second circulating mill is composed of the first or second or third or fourth or fifth or sixth circulating mill main engine and a second accessory device, the second accessory device is composed of a dust collector and an outer circulation pipe, the outer circulation pipe is provided with a dust collector ash discharge interface, the dust collector ash discharge interface is provided with an adjusting valve, a dust collector ash discharge pipe is provided with a discharge port, an air inlet of the dust collector is connected to the outlet of the circulating mill main engine, an outlet of the outer circulation pipe is connected to the inlet of the circulating mill main engine, and a dust collector ash discharge port is connected to the adjusting valve.

A third circulating mill is composed of the first or second or third or fourth or fifth or sixth circulating mill main engine and a third accessory device, the third accessory device is composed of a cyclone dust collector, a bag dust collector, and an outer circulation pipe, the outer circulation pipe is provided with a cyclone dust collector ash discharge interface, an air inlet of the cyclone dust collector is connected to the outlet of the circulating mill main engine, a cyclone dust collector exhaust outlet is connected to an air inlet of the bag dust collector, a cyclone dust collector ash discharge port is connected to the cyclone dust collector ash discharge interface on the outer circulation pipe, and an outlet of the outer circulation pipe is connected to the inlet of the circulating mill main engine.

A fourth circulating mill is composed of the first or second or third or fourth or fifth or sixth circulating mill main engine and a fourth accessory device, the fourth accessory device is composed of a cyclone dust collector, a bag dust collector, an outer circulation pipe, and an operation medium supply branch, the outer circulation pipe is provided with a cyclone dust collector ash discharge interface, an air inlet of the cyclone dust collector is connected to the outlet of the circulating mill main engine, a cyclone dust collector exhaust outlet is connected to an air inlet of the bag dust collector, a cyclone dust collector ash discharge port is connected to the cyclone dust collector ash discharge interface on the outer circulation pipe, an outlet of the outer circulation pipe is connected to the inlet of the circulating mill main engine, and an air inlet of the outer circulation pipe is connected to an exhaust outlet of the operation medium supply branch.

The third or fourth accessory device further includes a return device composed of a 1# conveyor and a 2# conveyor, the 1# conveyor is provided with one feed port and two discharge ports, one discharge port is a main discharge port of the circulating mill, the 2# conveyor is provided with two feed ports and two discharge ports, the feed port of the 1# conveyor is connected to an ash discharge port of the bag dust collector, the other discharge port of the 1# conveyor is connected to one feed port of the 2# conveyor, the other feed port of the 2# conveyor is connected to the cyclone dust collector ash discharge port, one discharge port of the 2# conveyor is provided with a valve, an outlet of the valve is connected to the cyclone dust collector ash discharge interface on the outer circulation pipe, and the other discharge port of the 2# conveyor is an auxiliary discharge port of the circulating mill.

In order to facilitate the processing of liquid materials, an atomizer may be disposed on the outer circulation pipe as a feeding device of the liquid materials.

In order to facilitate the processing of solid materials, the outer circulation pipe may be provided with a screw feeder as a feeding device, a discharge port is at a tail end of a material pipe of the screw feeder, a tail end bearing inner ring is fixed to a screw blade close to the tail end through a bearing sleeve, and a tail end bearing seat is fixed to the material pipe.

In order to achieve full closed loop operation, a feeding port of the screw feeder and a main discharge port and an auxiliary discharge port of the return device may be provided with an air-closing device formed by a valve, a storage pipe, and a valve connected successively.

In order to enable the fourth circulating mill to also use natural air as an operation medium, an air purification chamber of the bag dust collector of the fourth circulating mill is further provided with a second exhaust outlet with a cover, and the outer circulation pipe is further provided with a second air inlet with a cover.

In order to grind large hard materials, the present invention further provides a mine circulating mill, which is implemented by disposing a mill on an outer circulation pipe of an accessory device.

The operation medium supply branch of the fourth circulating mill is used to provide an operation medium in line with the process requirements for the circulating mill. The present invention provides six operation medium supply branches for the circulating mill. A first operation medium supply branch is composed of a heat exchanger, a condenser, and a heater, the heat exchanger being composed of a heat exchange branch and a cooling branch, heat medium channel air inlets of the heat exchange branch and the cooling branch being gathered together through a heat exchanger air inlet pipe, an inlet of the heat exchanger air inlet pipe being an air inlet of the operation medium supply branch, heat medium channel exhaust outlets of the heat exchange branch and the cooling branch being connected to an air inlet of the condenser, an exhaust outlet of the condenser being connected to a refrigerant channel of the heat exchange branch through a condenser exhaust pipe, an exhaust outlet of the refrigerant channel of the heat exchange branch being connected to an air inlet of the heater through a refrigerant channel exhaust pipe, an exhaust outlet of the heater being an exhaust outlet of the operation medium supply branch, and the air inlet of the operation medium supply branch being connected to the exhaust outlet of the bag dust collector.

A second operation medium supply branch is improved based on the first operation medium supply branch. Heat medium channel air intake volume adjusting devices of the heat exchange branch and the cooling branch are disposed in the heat exchanger air inlet pipe to adjust heat medium channel air volumes of the heat exchange branch and the cooling branch.

A third operation medium supply branch is composed of a first heat exchanger, a second heat exchanger, a condenser, and a heater, a heat medium channel inlet of the first heat exchanger being an air inlet of the operation medium supply branch, an outlet of the heater being an exhaust outlet of the operation medium supply branch, an air flow channel of the operation medium supply branch being formed by the heat medium channel of the first heat exchanger, a heat medium channel of the second heat exchanger, a heat medium channel of the condenser, an air duct, a refrigerant channel of the second heat exchanger, and a refrigerant channel of the heater connected sequentially, a refrigerant channel of the condenser being an evaporator of a heat pump, a heat medium channel of the heater being a condenser of the heat pump, and the air inlet of the operation medium supply branch being connected to the exhaust outlet of the bag dust collector.

A fourth operation medium supply branch is improved based on the third operation medium supply branch. A compressor exhaust pipe of the heat pump is provided with a switching valve to divide the exhaust pipe into two branches. A first branch enters the heater and then leads to a radiator, a second branch is in communication with a first branch coming out of the heater, and the air duct is provided with a pipeline with valves connected to the outlet of the heater.

Alternatively, the operation medium supply branch is a fifth operation medium supply branch that is a heater for heating an operation medium.

Alternatively, the operation medium supply branch is a sixth operation medium supply branch that is a cooler for cooling the operation medium.

In order to trigger physical and chemical reactions of the materials in the machine, the accessory device further includes an optical device composed of a tee joint, a light source, a reflector, and a dust-proof fan, an opening of the tee joint being connected to the outlet of the circulating mill main engine or the exhaust outlet of the cyclone dust collector, a second opening being connected to the air inlet of the cyclone dust collector or the bag dust collector, the light source being disposed in a third opening of the tee joint, the third opening of the tee joint being connected to an exhaust outlet of the dust-proof fan, an inlet of the dust-proof fan being in communication with an air purification chamber of the bag dust collector, and the reflector being configured to concentrate light on fluidized materials.

In order to strengthen irradiation of light on the fluidized materials, the optical device may also be implemented in such a way that the optical device is composed of a cross joint, a light source, a reflector, and a dust-proof fan, an opening of the cross joint being connected to the outlet of the circulating mill main engine or the exhaust outlet of the cyclone dust collector, a second opening being connected to the air inlet of the cyclone dust collector or the bag dust collector, the light source being disposed in a third opening and a fourth opening of the cross joint, and the third opening and the fourth opening of the cross joint being connected to an exhaust outlet of the dust-proof fan.

The optical device may also be a light source disposed in the air inlet of the outer circulation pipe and a reflector, the reflector being configured to concentrate light on fluidized materials; the optical device may also be a light source disposed in the exhaust outlet of the bag dust collector and/or in the exhaust outlet of the condenser; the physical and chemical reactions of the materials in the machine may also be caused by an acoustic device, which is a sound generator disposed on the main engine or/and the accessory device.

In order to achieve the second objective of the present invention, the present invention provides an application method of a circulating mill and a product processed by a circulating mill.

The circulating mill has a variety of configuration manners, which can meet processing requirements of different materials, and a typical configuration manner is as follows:

A first configured circulating mill is the fourth circulating mill, and a circulating mill main engine is the second circulating mill main engine.

A second configured circulating mill is the fourth circulating mill, a circulating mill main engine is the second circulating mill main engine, and an accessory device is provided with the third feeding device.

A third configured circulating mill is the first circulating mill, and a circulating mill main engine is the fourth circulating mill main engine.

A fourth configured circulating mill is the fourth circulating mill, a circulating mill main engine is the second circulating mill main engine, and an accessory device is provided with the second feeding device, the second return device, and the fourth operation medium supply branch.

A fifth configured circulating mill is the fourth circulating mill, a circulating mill main engine is the sixth circulating mill main engine, primary and secondary mills are provided with the third kinetic energy recovery impeller of which the diameter is 0.5 to 4 times that of the impeller, and an accessory device is provided with the fifth operation medium supply branch.

A sixth configured circulating mill is the fourth circulating mill, a circulating mill main engine is the sixth circulating mill main engine, primary and secondary mills are provided with the third kinetic energy recovery impeller of which the diameter is 0.5 to 4 times that of the impeller, and an accessory device is provided with a mill for grinding large hard materials.

(1) A processing method of plant fresh fruit powder and plant fresh fruit powder processed by same. The method is performed according to following steps: S1: washing fresh plants; and S2: adding materials treated in S1 into a circulating mill to make dry powder. Plant fresh fruit powder is the plant fresh fruit powder processed using the method.

(2) A method for spray drying by using a circulating mill and powder processed by same. The method includes adding materials to the second configured circulating mill, and obtaining made dry powder collected and discharged by the bag dust collector. Powder prepared by spray drying is the powder processed using the method.

(3) A processing method of feedstuff and a product processed by same. The method is performed according to following steps:

S1: preparation of raw material powder: adding feeding raw materials into the fifth configured circulating mill for processing to obtain dry feeding raw material powder; and S2: preparation of feedstuff: making the feeding raw material powder obtained in S1 into feedstuff. Feedstuff is the feedstuff processed using the method.

(4) A method for improving nutrient output of cultivated land and agricultural powder produced therefrom. The method is performed according to following steps: S1: seed selection: selecting suitable crop varieties based on unit yield, crop growth period, and plant nutrient content; S2: determination of the harvest time: determining the harvest time by maximizing “the harvest times in a year×nutrient yield per unit area”; the nutrient yield per unit area being the total amount of nutrients in the crop plant obtained from the previous harvest per unit planting area; S3: management measures: timely harvesting and timely sowing; S4: processing: S401: squeezing and dewatering: reducing the water content of harvested crops to less than 70% by squeezing and dewatering; S402: drying and powder-making: making the materials obtained in S401 into powder by using the fifth configured circulating mill; and S5: utilization: using the powder processed in S4 as raw food materials or feedstuff. Agricultural powder is the powder produced using the method.

(5) A pharmaceutical with volatile components as functional ingredients and a method for preparation and development thereof. The method is performed according to following steps: S1: large-scale preparation of volatile components: adding raw materials to the fourth configured circulating mill, and condensing, by the operating medium supply branch, gasified volatile components in the materials into liquid for discharge, so as to obtain liquid materials rich in volatile components; S2: separating and purifying the liquid materials rich in volatile components made in S1, to obtain materials with medicinal value; and S3: making the materials with medicinal value made in S2 into drugs, or studying the materials with medicinal value made in S2, and developing new drugs. A pharmaceutical with volatile components as functional ingredients is the pharmaceutical made or developed using the method.

(6) A method of simultaneously preparing volatile components in powder and powder feedstock and a product processed by same. The preparation method includes adding raw materials to the fourth configured circulating mill, collecting processed powder by a bag dust collector, changing the volatile components in the materials into a gaseous state during processing, and condensing, by the operation medium supply branch, the gaseous volatile components into liquid materials. The product is the powder or liquid volatile components processed using the method.

(7) A method for extracting volatile components from materials and a product processed by same. The method is performed according to following steps: adding raw materials to the fourth configured circulating mill, and condensing, by the operation medium supply branch, gaseous materials formed by gasification of the volatile components into liquid materials. A volatile component is the material made using the method.

(8) A preparation method of a plant dew beverage and a product processed by same. The method is performed according to following steps: S1: preparation of plant dew: removing impurities from fresh plants, washing them and adding them to the fourth configured circulating mill, and condensing, by the operation medium supply branch, gaseous water and gaseous volatile components formed by gasification of water and volatile components in the materials into liquid to obtain plant dew; and S2: beverage production: processing the plant dew obtained in step S1 into a plant dew beverage; or separating unneeded components from the plant dew obtained in step S1 to make a plant dew beverage. A plant dew beverage is the beverage made using the method.

(9) A crude oil distillation method and a product processed by same. The method is performed according to following steps: adding crude oil to the second configured circulating mill, and condensing, by the operation medium supply branch, gasified volatile components in the crude oil into liquid to obtain distillate. The product is the crude oil distillate prepared using the method.

(10) A method for producing sulfur-free konjac powder and a product processed by same. The method is performed according to following steps: S1: pre-processing of commodity fresh konjac: S101: washing and peeling; S102: cutting: cutting the konjac treated in S101 into pieces, wherein the pieces need not be regular, but the konjac with defects of bud eyes, insect holes, different color spots, plant root spots, root holes and wormholes is cut together, and the konjac without defects is cut together; S103: grading: grading the cut konjac pieces while the konjac is cut into pieces, with the defective ones as one grade and the non-defective ones as another grade; S104: squeezing and dewatering: reducing the water content of the konjac pieces graded in S103 to less than 75% by squeezing and dewatering; S2: customization of an operation medium: adjusting the operation medium to include an oxygen component of less than 10%; and S3: drying and powder-making: adding the konjac pieces of two grades processed in S1 to the fourth configured circulating mill to make sulfur-free konjac powder. Sulfur-free konjac powder is the konjac powder produced using the method.

(11) A method for producing starch and a product processed by same. The method is performed according to following steps: S1: pre-processing: removing impurities from raw materials and washing the raw materials; S2: drying and powder-making: adding the materials processed in step S1 to the first configured circulating mill to make powder; S3: starch separation: mixing the powder made in S2 with water for full agitation, and separating the starch after settling to obtain wet starch; and S4: adding the wet starch obtained in S3 to the fourth configured circulating mill for drying to obtain starch. Plant starch is the starch made using the method.

(12) A processing and utilization method of fertilizers and a product processed by same. The method is performed according to following steps: S1: preparation of fertilizer raw materials: making raw materials into powder by using the first configured circulating mill to obtain fertilizer raw material powder; or adding raw materials and other ingredients to the third configured circulating mill to make them into powder to obtain fertilizer raw material powder; and S2: utilization: using the fertilizer raw materials processed in step S1 as fertilizers; or processing the fertilizer raw material powder processed in step S2 into fertilizers. A fertilizer is the fertilizer made using the method.

(13) A preparation method for barley seedling powder and a product processed by same. The method is performed according to following steps: S1: pre-processing: removing impurities from harvested fresh barley seedlings and washing them; and S2: drying and powder-making: adding the barley seedlings processed in step S1 to the fourth configured circulating mill to make them into powder. Barley seedling powder is the barley seedling powder made using the method.

(14) A processing method for hemp seed protein powder and a product processed by same. The method is performed according to following steps: S1: pre-processing: shelling hemp seed for oil manufacture; and S2: preparation of protein powder: making the materials processed in S1 into powder by using the fourth configured circulating mill. Hemp seed protein powder is the hemp seed protein powder processed using the method.

(15) A processing and utilization method of hemp stem powder and a product. The method is performed according to following steps: S1: pre-processing: cutting hemp stem; or pre-crushing hemp stem into a length of 200 mm, and peeling the hemp stem; or peeling hemp stem and then pre-crushing the hemp stem into a length of 200 mm; S2: preparation of hemp stem powder: making the materials treated in S1 into powder by using the third configured circulating mill to obtain hemp stem powder; S3: utilization of hemp stem powder: pressing the hemp stem powder processed in S2 into profiles; or using the hemp stem powder processed in S2 as toothpaste fillers; or adding excipients to the hemp stem powder processed in S2 and pressing them to make profiles. Hemp stem powder is processed using the method. A profile is processed using the method. A toothpaste filler is the toothpaste filler processed using the method.

(16) A method for primary processing of hemp flower and leaf in a production area and a product processed by same. The method includes drying and pulverizing fresh hemp flower and leaf by using the fourth configured circulating mill to obtain hemp flower and leaf powder. Hemp flower and leaf powder is the hemp flower and leaf powder made using the method.

(17) A preparation method for dry granulation raw material powder and a product processed by same. The method includes adding raw materials to the fourth configured circulating mill to simultaneously complete grinding, mixing, and drying to obtain raw material powder required by dry granulation. Dry granulation raw material powder is the product processed using the method.

(18) A processing method of fish powder and a product processed by same. The method includes adding fresh fish to the fourth configured circulating mill to make powder. Fish powder is the fish powder processed using the method.

(19) A processing method of feeding bone powder and a product processed by same. The method includes adding fresh bone to the fourth configured circulating mill to make powder. Feeding bone powder is the product processed using the method.

(20) A preparation method of extract and a product processed by same. The method includes following steps: S1: preparation of raw material powder: making fresh raw materials into powder by using the fourth configured circulating mill; S2: preparing an extracting solution, S201: mixing the powder obtained in S1 with a solvent to dissolve extract, to obtain mixture slurry of an extracting solution and slag; S202: separation of the slag and the extracting solution: separating the mixture slurry made in S201 to obtain the extracting solution and the slag; S203: extraction of residual extract from slag: mixing the slag obtained in S202 with a solvent to dissolve residual extract in the slag, to obtain mixture slurry of an extracting solution and slag; separating the slag and the extracting solution by using the method in S202; repeating step S203, till the residual extract in the slag is no longer economically valuable to extract; S204: purification of the extracting solution: removing impurities from the extracting solution and purifying the extracting solution; S3: drying of the extracting solution: drying the extracting solution made in S2 by using the second configured circulating mill to obtain extract; and S4: drying of the slag: making the slag made in S2 into powder by using the fourth configured circulating mill. Extract is the extract made using the method.

(21) A processing method of forage grass and a product processed by same. The method includes making fresh forage grass or forage grass naturally dried for 1 to 5 days into powder by using the fifth configured circulating mill. Forage grass powder is the forage grass powder processed using the method.

(22) A preparation method of mineral powder and a product processed by same. The method is performed according to following steps: adding raw mineral materials to the sixth configured circulating mill through a feeding port of a mineral mill, pre-crushing, by the mill, the materials into coarse powder, driving, by an air flow in an outer circulation pipe, the coarse powder into the circulating mill main engine to further crush it into fine powder, and collecting fine powder with a required particle size separated out and entering the bag dust collector with the air flow to obtain mineral powder. Mineral powder is the mineral powder prepared using the method.

(23) A preparation method of perfume using plant aroma as functional components and a product processed by same. The method is performed according to following steps: S1: preparation of cell fluid: adding fresh plants to the fourth configured circulating mill for processing, and condensing, by the operation medium supply branch, gaseous water and gaseous volatile components formed by gasification of water and volatile components in the materials to obtain cell fluid; and S2: preparation of perfume: making the cell fluid obtained in S2 into perfume. Perfume is the perfume made using the method.

(24) A preparation method of fresh corn flour and a product processed by same. The method includes: S1: harvesting fresh corn and choosing fresh and tender corn to harvest; S2: shelling and threshing: shelling and threshing the fresh tender corn harvested in step S1 to obtain fresh corn kernels; and S3: preparation of fresh corn flour: adding the fresh corn kernels prepared in step S2 to the fourth configured circulating mill to make fresh corn flour. Fresh corn flour is the fresh corn flour made using the method.

(25) A preparation method of fresh bean flour and a product processed by same. The method includes: S1: harvesting fresh beans and choosing fresh beans near the end of a grain-filling period to harvest; S2: shelling: shelling the fresh beans harvested in step S1 to obtain fresh bean kernels; and S3: preparation of fresh bean flour: adding the fresh bean kernels prepared in step S2 to the fourth configured circulating mill to make fresh bean flour. Fresh bean flour is the fresh bean flour made using the method.

(26) A preparation method of fresh wheat flour and a product processed by same. The method includes: S1: harvesting fresh wheatears and choosing fresh wheatears near the end of a grain-filling period to harvest; S2: shelling: shelling the wheatears harvested in step S1 to obtain fresh wheat grains; and S3: preparation of fresh wheat flour: adding the fresh wheat grains prepared in step S2 to the fourth configured circulating mill to make fresh wheat flour. Fresh wheat flour is the fresh wheat flour made using the method.

(27) A preparation method of fresh rice flour and a product processed by same. The method includes: S1: harvesting rice and choosing rice near the end of a grain-filling period to harvest; S2: preparation of rice milk: removing rice milk from the rice harvested in step S1; and S3: drying of the rice milk: adding the rice milk prepared in step S2 to the fourth configured circulating mill to make fresh rice flour. Fresh rice flour is the fresh rice flour made using the method.

(28) A preparation method of potato powder and a product processed by same. The method includes: controlling the oxygen content of an operation medium to less than 8%, washing, peeling or unpeeling potatoes, and adding the potatoes to the fourth configured circulating mill to make dry powder. Potato powder is the potato powder made using the method.

(29) A preparation method of pumpkin powder and a product processed by same. The method includes: washing and peeling pumpkin, removing pulp, and adding the pumpkin to the fourth configured circulating mill to make dry powder. Pumpkin powder is the pumpkin powder made using the method.

(30) A preparation method of tomato powder. The method includes: washing fresh tomatoes, and adding the tomatoes to the fourth configured circulating mill to make dry powder. Tomato powder is the tomato powder made using the method.

The same method can also be used to prepare green onion powder, ginger powder, cucumber powder, watermelon powder, pepper powder, garlic bolt powder, cabbage powder, bitter cabbage powder, carrot powder, tea powder, edible rose powder, coffee powder, edible powder, and the like.

(31) A preparation method of rose cell fluid and a product processed by same. The method includes: adding rose to the fourth configured circulating mill, and condensing, by the operation medium supply branch, vaporized moisture and rose scent into liquid. Rose cell fluid is the rose cell fluid made using the method.

The same method can also be used to prepare cell fluid of fresh agricultural products such as garlic, apple, cantaloupe, and Chinese herbal medicines.

(32) A preparation method of fresh maca powder and maca glucosinolates and a product processed by same. The method is performed according to following steps: S1: washing fresh maca and adding the maca to the fourth configured circulating mill; S2: collecting fresh maca powder by the bag dust collector, and collecting maca cell fluid by the operation medium supply branch; and S3: purifying the maca cell fluid obtained in S2 to obtain maca glucosinolates. Fresh maca powder is made using the method. A maca glucosinolate is the maca glucosinolate made using the method.

(33) A preparation method of instant coffee and instant coffee processed by same. The method includes: S1: preparation of coffee powder: adding fresh or dried coffee beans to the fourth configured circulating mill to make dry powder; S2: preparation of coffee liquid: adding the coffee powder obtained in S1 to water, to dissolve soluble components in the coffee powder into the water to obtain mixture slurry of coffee liquid and coffee grounds, and filtering the mixture slurry to obtain the coffee liquid; S3: drying and powder-making of the coffee liquid: adding the coffee liquid obtained in S2 to the second configured circulating mill to make dry powder to obtain instant coffee. Instant coffee is the instant coffee made using the method.

(34) A preparation method of milk powder and a product processed by same. The method includes: adding emulsion to the second configured circulating mill to make milk powder. Milk powder is the milk powder made using the method.

(35) A preparation method of soybean milk powder and a product processed by same. The method includes: adding soybean milk to the second configured circulating mill to make soybean milk powder. Soybean Milk powder is the milk powder made using the method.

(36) A preparation method of Chinese herbal medicine powder and Chinese herbal medicine cell fluid and a product processed by same. The method includes: washing Chinese herbal medicines and adding them to the fourth configured circulating mill, discharging dry Chinese herbal medicine powder from a main discharge port, and collecting Chinese herbal medicine cell fluid by the operation medium supply branch. Chinese herbal medicine powder is the Chinese herbal medicine powder made using the method. Chinese herbal medicine cell fluid is the Chinese herbal medicine cell fluid prepared using the method.

(37) A preparation method of ginseng powder and ginseng cell fluid and a product processed by same. The method includes: washing ginseng and adding it to the fourth configured circulating mill, discharging ginseng powder from a main discharge port, and collecting ginseng cell fluid by the operation medium supply branch. Ginseng powder is made using the method. Ginseng cell fluid is the ginseng cell fluid prepared using the method.

The same method can also be used to prepare the following Chinese herbal medicine powder and cell fluid thereof: radix linderae, atractylodes, radix paeoniae alba, fritillaria, hyacinth bletilla, American ginseng, red ginseng, Chinese yam, chrysanthemum morifolium ramat, rhizoma corydalis, radix scrophulariae, radix ophiopogonis, radix curcumae, notoginseng, pine needles, pear, notoginseng flower, notoginseng leaf, gastrodia elata, erigeron breviscapus, caulis dendrobii, radix angelicae sinensis, magnolia officinalis, radix scutellariae, amomum villosum, polygonum multiflorum, resina draconis, radix aconiti brachypodi, common alstonia leaf, kusnezoff monkshood root, pinellia, radix geutianae, eucommia, radix saposhnikoviae, poria cocos, honeysuckle, rhizoma polygonati, cordyceps sinensis, radix bupleuri, radix codonopsis, pepper, radix isatidis, aloe vera, amomum, rhizoma paridis, rhizoma ligustici wallichii, cordate houttuynia, loquat leaf, croton, gallnut, cornus, radix dipsaci, rhodiola, sea buckthorn powder, desertliving cistanche, astragalus, licorice, Chinese wolfberry, spikenard, valerian, red paeony root, notopterygium, selfheal, radix angelicae pubescentis, lily, radix polygonati officinalis, gynostemma, Chinese bulbul, cowherb seed, fruit of Chinese magnoliavine, dodder, hawthorn, artemisinin, cortex periplocae, moringa leaf, rhizoma zedoariae, gardenia, folium artemisiae argyi, cinnamon, ageratum, fructus anisi stellati, ganoderma lucidum, ganoderma lucidum spore, wild fungus, mushrooms, stevia, rhizoma acori tatarinowii, radix puerariae, radix pseudostellariae, phytolacca acinosa, polygonum cuspidatum, rhubarb, paniculate swallowwort root, motherwort, sophora, chrysanthemum, gordon euryale seed, tribulus terrestris, rhizoma bistortae, rhizoma drynariae, herba artemisiae scopariae, fructus arctii, forsythia, herba schizonepetae, uncaria, daphne genkwa, mint, coix seed, fructus xanthii, rhizoma arisaematis, radix fici hirtae, sargentodoxa cuneata, lysimachia christinae hance, raspberry, dogbane leaf, radix ranunculi ternati, semen cassiae, platycodon grandiflorum, papaya, radix sanguisorbae, fructus gleditsiae sinensis, antipyretic dichroa, cirsium japonicum, radix aconiti carmichaeli, radix peucedani, acanthopanax, rhizoma anemarrhenae, lycium ruthenicum, rhizoma alismatis, saffron, cardamom, matsutake, osmanthus fragrans, saussurea involucrata, folium mori, eurycoma longifolia, and the like.

(38) A preparation method of gecko powder and a product processed by same. The method includes: removing impurities from fresh geckos, washing them, and adding them to the fourth configured circulating mill to make dry powder. Gecko powder is processed using the method. The same method can also be used to prepare following animal powder: cuttlefish bone, leech, bezoar, deer antler, bear bile, ground beeltle, cantharidopsis powder, cicada slough, ant, centipede, pearl, black chicken, pig blood, eel, cubilose, crab shell, and the like.

(39) A preparation method of medicinal talc powder. The method includes: adding talc powder raw material to the fourth configured circulating mill to make dry powder. Medicinal talc powder is the talc powder processed using the method.

The same method can also be used to prepare medicinal mirabilite powder, medicinal gypsum powder, and the like.

(40) A preparation method of seaweed powder and a product processed by same. The method includes: draining fresh seaweeds and adding them to the fourth configured circulating mill to make dry powder. Seaweed powder is the seaweed powder processed using the method.

(41) A preparation method of fragmented spirulina powder and a product processed by same. The method includes: adding fresh spirulina to the fourth configured circulating mill to make fragmented spirulina powder. Fragmented spirulina powder is the fragmented spirulina powder processed using the method.

(42) A preparation method of putty for construction and a product processed by same. The method includes: adding raw putty materials for construction to the sixth configured circulating mill to make powder. Putty for construction is the putty for construction processed using the method.

(43) A grinding method for cement clinker and a product processed by same. The method includes: operating the sixth configured circulating mill to add cement clinker to equipment through a feeding port of the mill, pre-crushing, by the mill, the materials into coarse powder, and driving, by an air flow in an outer circulation pipe, the coarse powder into the circulating mill main engine to further crush it into fine powder which is separated by the bag dust collector to obtain cement powder. Cement is the cement processed using the method.

The same method can also be used to prepare titanium dioxide, calcium carbonate, lithopone, kaolin powder, coal powder, stone powder, ore powder, gypsum powder, feldspar powder, graphite powder, silica powder, and the like.

(44) A grinding method of iron powder and a product processed by same. The method includes: pre-fabricating iron powder raw materials into small pieces below 5 mm and adding them to the circulating mill to make fine powder. Iron powder is the iron powder processed using the method.

The same method can also be used to process tungsten powder, copper powder, cobalt powder, nickel powder, titanium powder, tantalum powder, aluminum powder, tin powder, lead powder, and other metal powder.

(45) A grinding method of pesticide powder and a product processed by same. The method includes: adding pesticide raw materials to the fourth configured circulating mill to make fine powder. Pesticide powder is the pesticide powder processed using the method.

(46) A method of sea water desalinization and a product processed by same. The method includes: adding sea water to the second configured circulating mill for spray drying, and condensing, by the operation medium supply branch, vaporized moisture into liquid water to obtain fresh water. Fresh water is the fresh water processed using the method.

(48) A method of drying sludge. The method includes adding sludge into the fifth configured circulating mill to make dry powder. Sludge is the sludge processed using the method.

The method can also be used to process sewage sludge, septic tank sludge, farm manure, kitchen waste, tailings discharged from water treatment equipment, vegetable waste, and other high-humidity and high-viscosity materials.

(49) A method of processing edible and medicinal powder and retrieving cell fluid and a product processed by same. The method includes: washing edible and medicinal raw materials and adding them to the fourth configured circulating mill to make powder, obtaining the powder discharged from a first discharge port of the second return device, and condensing, by the operation medium supply branch, gaseous water and gaseous volatile components generated during processing into liquid to obtain cell fluid. Edible and medicinal powder is processed using the method. Cell fluid is the cell fluid prepared using the method.

(50) A preparation method of banana powder and banana powder. The method includes controlling the oxygen content in the operation medium to be less than 5% by mass, and making edible parts of bananas into banana powder by using the fourth configured circulating mill. Banana powder is the banana powder processed using the method.

(51) A preparation method of green banana powder and green banana powder. The method includes: controlling the oxygen content in the operation medium to be less than 5% by mass, and making peeled or unpeeled green bananas into green banana powder by using the fourth configured circulating mill. Green Banana powder is the banana powder processed using the method.

(52) A fragmentation method for washed pine pollen and washed fragmented pine pollen. The method includes centrifugally dehydrating washed pine pollen with water content of 65% to 75% into fragmented powder by using the fourth configured circulating mill. Washed fragmented pine pollen is the washed fragmented pine pollen processed using the method.

(53) A drying method for juice prepared by pressing and a product processed by same. The method is performed according to following steps: S1: equipment configuration: selecting the second configured circulating mill, and selecting nitrogen with oxygen content less than 6% as the operation medium; and S2: adding the juice prepared by pressing to the equipment configured in S1 to make powder, and obtaining the powder discharged from a maim discharge port. Powder processed from juice prepared by pressing is the powder processed using the method.

(54) A preparation method of barley green and a product processed by same. The method is performed according to following steps: S1: equipment configuration: selecting the second configured circulating mill, and controlling the oxygen content of the operation medium to be less than 5%; S2: preparing barley grass juice: S201: treatment of raw materials: rinsing tender barley grass; S202: juicing: juicing the barley grass prepared in S201 to obtain barley grass juice; S203: filtering: filtering solid substances in the barley grass juice prepared in S202 to obtain fine barley grass juice; and S3: spray drying: adding the fine barley grass juice prepared in S2 to the equipment configured in S1 for spray drying, and obtaining barley green discharged from a main discharge port. Barley green is the barley green processed using the method.

(55) A preparation method of soluble notoginseng powder and soluble notoginseng powder. The method includes making fresh notoginseng juice prepared by pressing into soluble notoginseng powder by using the second configured circulating mill. Soluble notoginseng powder is the soluble notoginseng powder processed using the method.

The same method can also be used to prepare soluble maca powder, soluble apple powder, soluble emblic leafflower fruit powder, soluble matsutake powder, and the like.

(56) A fragmentation method of pine pollen and a product processed by same. The method is performed according to following steps: S1: configuring equipment: S101: employing the fourth circulating mill and the second circulating mill main engine, and configuring the accessory device with the fourth operation medium supply branch, S102: configuring the accessory device with the second feeding device and the second return device, S103: configuring the third or fourth optical device, and selecting an ultraviolet sterilization light source as the light source of the optical device, S104: setting the switching valve of the fourth operation medium supply branch to make the compressor exhaust pipe connected to the second branch and disconnected from the first branch, and opening the valve on the pipeline between the air duct and the outlet of the heater, S105: selecting nitrogen with oxygen content less than 10% as the operation medium; and S2: fragmentation of pine pollen: adding pine pollen to the equipment configured in S1 to make fragmented pine pollen. Fragmented pine pollen is the fragmented pine pollen processed using the method.

(57) A preparation method of ultrafine powder of Chinese herbal medicines. The method includes: making dry Chinese herbal medicines into ultrafine powder by using the equipment configured in step S1 in the fragmentation method of pine pollen and the product processed by same in (56). Ultrafine powder of Chinese herbal medicines is the ultrafine powder of Chinese herbal medicines processed using the method.

In the circulating mill of the present invention, a kinetic energy recovery device is disposed in the circulating mill main engine to implement recovery and utilization of high-speed fluidized kinetic energy, an energy efficiency ratio of the operation medium supply branch is increased to more than 6 by using a natural cold source to assist in cooling high-temperature tail gas, and a feeding device is employed to increase the quantity of return and improve the fluidity of materials, which improves the economy and reliability of the circulating mill described in the invention patent 2018111102064. The application method of the circulating mill according to the present invention solves a common pain point problem of poor quality or high cost of traditional drying and grinding methods, and provides an economical solution for processing of forage agricultural products, processing of Chinese herbal medicines, drying of liquid materials, grinding of minerals, preparation of metal powder, preparation of pharmaceuticals with volatile components as functional ingredients, sludge drying, and the like. Thee product processed by the circulating mill in the present invention eliminates the link that causes the quality problem during processing of the traditional method, the product quality is good, and the processing cost is low.

### BRIEF DESCRIPTION OF DRAWINGS

FIG. 1 is a first circulating mill according to Embodiment 1;

FIG. 2 is a second circulating mill according to Embodiment 2 and a third circulating mill according to Embodiment 3;

FIG. 3 is a kinetic energy recovery blade of a second circulating mill according to Embodiment 4;

FIG. 4 is a first kinetic energy recovery impeller according to Embodiment 5;

FIG. 5 is a second kinetic energy recovery impeller according to Embodiment 6;

FIG. 6 is a third kinetic energy recovery impeller according to Embodiment 7;

FIG. 7 is a fourth kinetic energy recovery impeller according to Embodiment 8;

FIG. 8 is a first circulating mill main engine according to Embodiment 9;

FIG. 9 is a second circulating mill main engine according to Embodiment 10;

FIG. 10 is a fourth circulating mill main engine according to Embodiment 12;

FIG. 11 is a seventh circulating mill main engine according to Embodiment 15;

FIG. 12 is first and second operation medium supply branches according to Embodiment 17;

FIG. 13 is a third operation medium supply branch according to Embodiment 18;

FIG. 14 is a fourth operation medium supply branch according to Embodiment 19;

FIG. 15 is a return device of a circulating mill according to Embodiment 20;

FIG. 16 is a first circulating mill according to Embodiment 21;

FIG. 17 is a second circulating mill according to Embodiment 22;

FIG. 18 is a third circulating mill according to Embodiment 23;

FIG. 19 is a fourth circulating mill according to Embodiment 24;

FIG. 20 is a screw feeder for a circulating mill according to Embodiment 25; and

FIG. 21 is an optical device and an acoustic device according to Embodiment 26.

### DETAILED DESCRIPTION OF PREFERRED EMBODIMENTS

The present invention is further described below with reference to drawings and embodiments, but the embodiments do not constitute limitations on the present invention. The embodiments provided in the present invention are obviously insufficient to demonstrate the full application of the present invention. Those skilled in the art should understand that without deviating from the technical features of the present invention, various combinations can be made to achieve specific purposes and various modifications can be made to meet different requirements. Therefore, the present invention is not limited to specific embodiments disclosed below, but includes all possible embodiments falling within the scope of the claims and solutions, use and application methods of the circulating mill equipment and the products processed by the circulating mill which are readily available through the present invention.

Embodiment 1: A first circulating mill is improved based on a centrifugal fan, which, as shown on the left of FIG. 1, is composed of a housing 1, a kinetic energy recovery device, and an impeller 2. The housing is provided with an inner circulation pipe interface 3 near an air inlet. An air flow from the inner circulation pipe interface 3 drives or assists in driving the impeller to rotate by impacting the kinetic energy recovery device. As shown on the right of FIG. 1, the kinetic energy recovery device is implemented in such a way that an air inlet on a front disc 6 expands to expose a blade 7, and the air flow from the inner circulation pipe interface assists in driving the impeller to rotate by impacting the exposed blade 7. Alternatively, as shown in FIG. 1, an air inlet on a front disc 4 expands to expose a blade 5, and the air flow from the inner circulation pipe interface assists in driving the impeller to rotate by impacting the exposed blade 5.

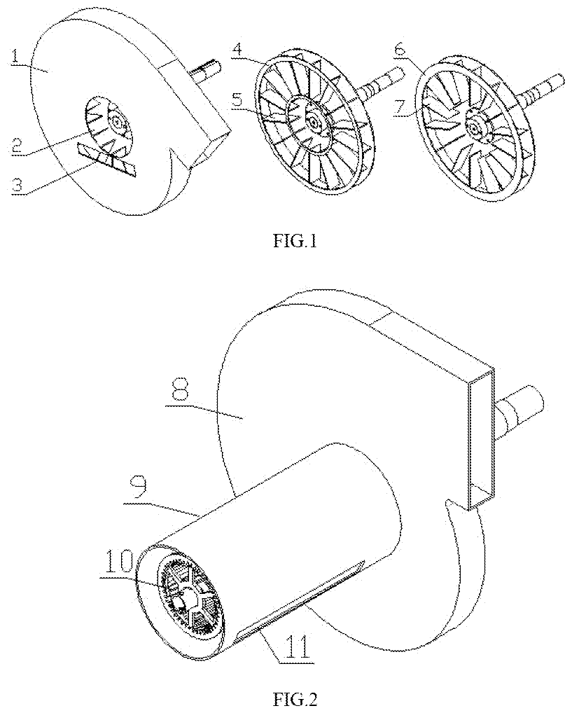

Embodiment 2: A second circulating mill is improved based on a centrifugal fan, which, referring to FIG. 2, is composed of a housing 8, an impeller, a kinetic energy recovery device 10, and a feed pipe 9. The feed pipe 9 is provided with an inner circulation pipe interface 11, one end of the feed pipe is connected to an air inlet on the housing 8, the kinetic energy recovery device 10 is disposed in the feed pipe 9, an air flow from the inner circulation pipe interface 11 drives or assists in driving the impeller to rotate by impacting the kinetic energy recovery device 10, the other end of the feed pipe is an inlet of the second circulating mill, and an air outlet on the housing is an outlet of the second circulating mill.

Embodiment 3: A third circulating mill is improved based on a centrifugal fan, which, referring to FIG. 2, is composed of a housing 8, an impeller, a kinetic energy recovery device 10, and a feed pipe 9. The feed pipe 9 is provided with an inner circulation pipe interface 11, one end of the feed pipe is connected to an air inlet on the housing 8, the kinetic energy recovery device 10 is disposed in the feed pipe 9, the impeller is driven to rotate by the kinetic energy recovery device 10 impacted by the air flow from the inner circulation interface 11, the other end of the feed pipe is an inlet of the second circulating mill, and an air outlet on the housing is an outlet of the second circulating mill.

The second circulating mill and the third circulating mill are basically the same in structure and are different in that the air flow from the inner circulation pipe interface assists only in driving the impeller of the second circulating mill to rotate and the impeller of the third circulating mill can be driven to rotate completely by the kinetic energy recovery device impacted by the air flow from the inner circulation interface.

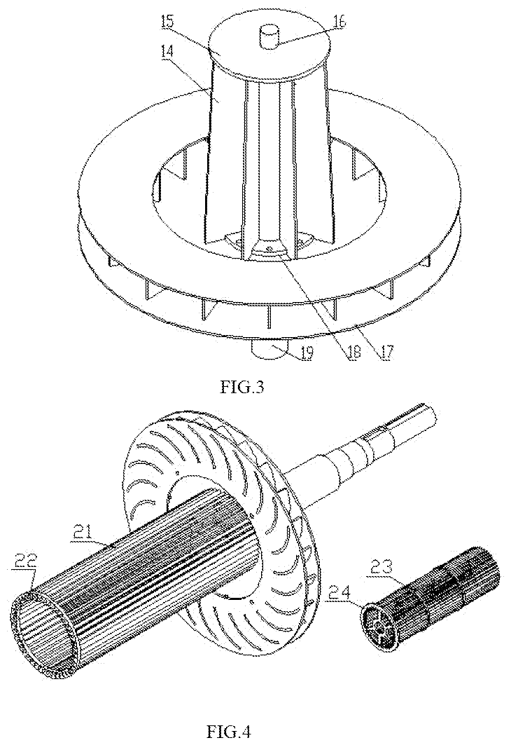

Embodiment 4: In a kinetic energy recovery blade of the second circulating mill, referring to FIG. 3, one end of the kinetic energy recovery blade 14 is fixed to a rear disc 17 and/or a shaft sleeve 18 and/or an impeller shaft 19, and the other end is fixed to an impeller shaft 16 elongating along a feed pipe, or the other end is fixed to a connecting plate 15. The connecting plate 15 is fixed to the impeller shaft 16 elongating along the feed pipe. The kinetic energy recovery blade of the second circulating mill may also be implemented in a simpler way that the kinetic energy recovery blade is fixed to an impeller shaft or fixed to an impeller shaft elongating along a feed pipe.

Embodiment 5: A first kinetic energy recovery impeller, referring to FIG. 4, is composed of a kinetic energy recovery blade 21 and an upper ring 22. One end of the kinetic energy recovery blade 21 is fixed to a shaft sleeve and/or a rear disc, the other end is fixed to the upper ring 22, and a plurality of kinetic energy recovery blades are distributed circumferentially along the upper ring; or the upper ring 24 is fixed to an impeller shaft elongating along a feed pipe; or the first kinetic energy recovery impeller further includes a reinforcing ring 23. The reinforcing ring 23 is fixed to a middle part of the kinetic energy recovery blade or the reinforcing ring 23 is fixed to a middle part of the kinetic energy recovery blade and an impeller shaft elongating along a feed pipe.

Embodiment 6: A second kinetic energy recovery impeller, referring to FIG. 5, is composed of a kinetic energy recovery impeller shaft sleeve 25, a kinetic energy recovery blade 26, and an upper ring 27. One end of the kinetic energy recovery blade 26 is fixed to the kinetic energy recovery impeller shaft sleeve 25, the other end is fixed to the upper ring 27, a cross section of the kinetic energy recovery blade 26 is semi-circular or wing-shaped or a windward side of the kinetic energy recovery blade 26 is flat, a leeward side is cambered, and a kinetic energy recovery impeller shaft sleeve 29 is fixed to a shaft sleeve 28 or an impeller shaft; the upper ring is fixed to an impeller shaft 30 elongating along a feed pipe. The elongated impeller shaft is provided with bearings fixed to a bracket 31, and the bracket 31 is fixed to the feed pipe and a base.

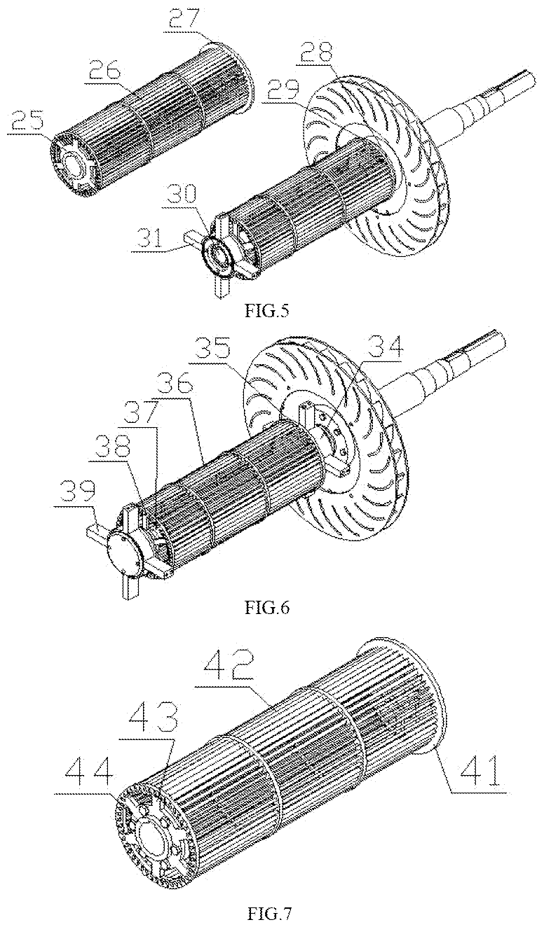

Embodiment 7: A third kinetic energy recovery impeller, referring to FIG. 6, is composed of a kinetic energy recovery impeller shaft sleeve 35, a kinetic energy recovery impeller shaft 37, a kinetic energy recovery blade 36, an upper ring 38, and a transmission 34. One end of the kinetic energy recovery blade 36 is fixed to the kinetic energy recovery impeller shaft sleeve 35, the other end is fixed to the upper ring 38, the transmission 34 is fixed to a feed pipe and a base, an input shaft of the transmission 34 is the kinetic energy recovery impeller shaft 37, the kinetic energy recovery impeller shaft sleeve 35 and the upper ring 38 are fixed to the input shaft of the transmission, and an output shaft of the transmission is an impeller shaft or connected to an impeller shaft, one end of the input shaft of the transmission extending out of the upper ring is provided with bearings fixed to a bracket 39, and the bracket 39 is fixed to the feed pipe and the base. In order to efficiently recover the kinetic energy of fluidized materials, the diameter of the kinetic energy recovery impeller in this embodiment is 1.5 times that of the impeller.

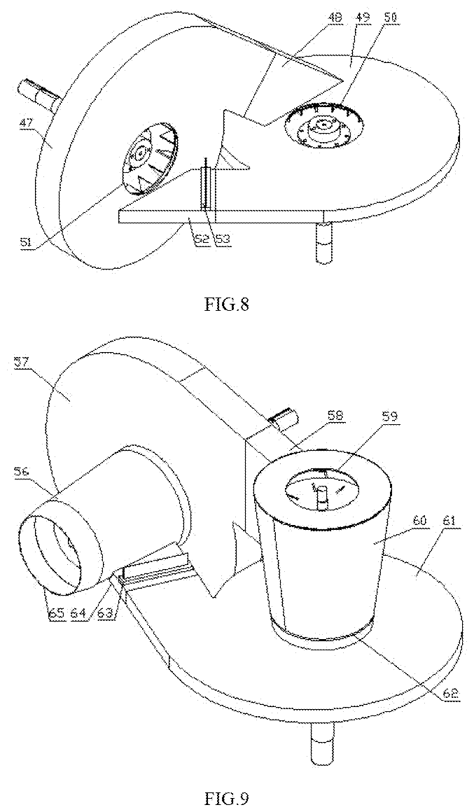

Embodiment 8: A fourth kinetic energy recovery impeller, referring to FIG. 7, is composed of a kinetic energy recovery impeller shaft sleeve 44, a lower ring 43, a kinetic energy recovery blade 42, and an upper ring 41. One end of the kinetic energy recovery blade 42 is fixed to the lower ring 43, the other end is fixed to the upper ring 41, and the lower ring 43 is fixed to the kinetic energy recovery impeller shaft sleeve 44.

Embodiment 9: A first circulating mill main engine, referring to FIG. 8, is composed of a primary mill 47, a secondary mill 49, and an inner circulation pipe. The primary mill and the secondary mill are the first circulating mill according to Embodiment 1, an outlet of the primary mill is connected to an inner circulation pipe interface of the secondary mill through an inner circulation pipe 48, an outlet of the secondary mill is connected to an inner circulation pipe interface of the primary mill through an inner circulation pipe 52, an inlet 51 of the primary mill is an inlet of the circulating mill main engine, and an inlet 50 of the secondary mill is an outlet of the circulating mill main engine. An axis of the primary mill 47 is perpendicular to that of the secondary mill 49. A cross sectional area of the outlet of the secondary mill is 29% of that of the outlet of the primary mill. The inner circulation pipe 52 between the outlet of the secondary mill and the inner circulation pipe interface of the primary mill is provided with an air volume adjusting device 53.

Embodiment 10: A second circulating mill main engine, referring to FIG. 9, is composed of a primary mill 57, a secondary mill 61, and an inner circulation pipe. The primary mill 57 and the secondary mill 61 are the second circulating mill according to Embodiment 2, an outlet of the primary mill 57 is connected to an inner circulation pipe interface on a feed pipe 60 of the secondary mill 61 through an inner circulation pipe 58, an outlet of the secondary mill 61 is connected to an inner circulation pipe interface on a feed pipe 56 of the primary mill through an inner circulation pipe 64, an inlet of the primary mill is an inlet 65 of the circulating mill main engine, and an inlet of the secondary mill is an outlet 59 of the circulating mill main engine. An axis of the primary mill 57 is perpendicular to that of the secondary mill 61. A cross sectional area of the outlet of the secondary mill is 26% of that of the outlet of the primary mill. The inner circulation pipe 64 between the outlet of the secondary mill and the inner circulation pipe interface of the primary mill is provided with an air volume adjusting device 63. The feed pipe 60 of the secondary mill is also provided with an air volume adjusting device 62. The air volume adjusting device 62 is disposed between the inner circulation pipe interface and one end of the feed pipe.

Embodiment 11: A third circulating mill main engine is based on the second circulating mill main engine according to Embodiment 10 from which the kinetic energy recovery devices of the primary mill and the secondary mill are removed. The third circulating mill main engine in this embodiment is simpler in structure than the second circulating mill main engine in Embodiment 10, which has a certain significance in processing dry materials without considering an energy-saving effect.

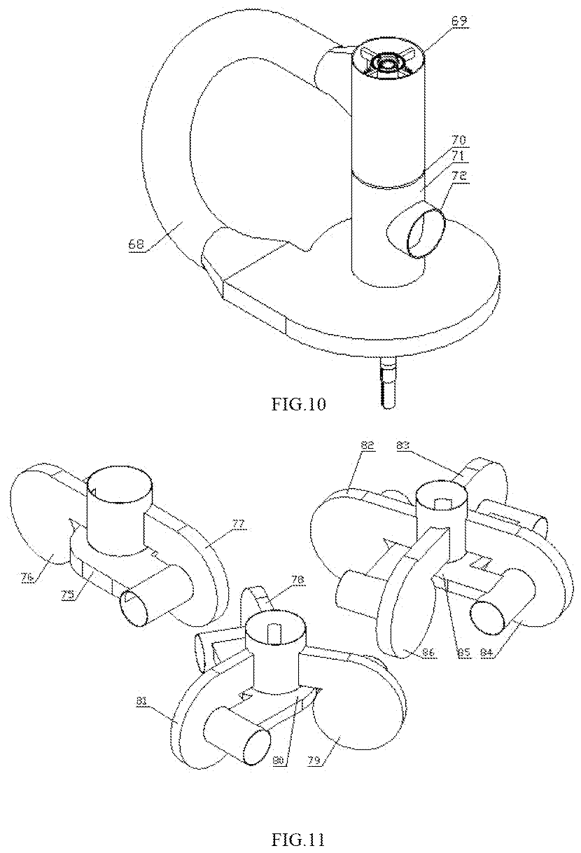

Embodiment 12: A fourth circulating mill main engine, referring to FIG. 10, is improved based on the second circulating mill main engine according to Embodiment 2. An outlet on the housing is connected to an inner circulation pipe interface on the feed pipe through an inner circulation pipe 68, a three-way air inlet 71 is disposed between one end of the feed pipe and the air inlet on the housing, a second opening of the three-way air inlet is an inlet 72 of the fourth circulating mill main engine, and the other end of the feed pipe is an outlet 69 of the circulating mill main engine. An air volume adjusting device 70 is disposed between one end of the feed pipe and the three-way air inlet 71.

The fourth circulating mill main engine in Embodiment 12 is simpler in structure that the first and second circulating mill main engines in Embodiments 9 and 10, but due to the bending of the inner circulation pipe, the wall hanging is more serious, and the equipment cost has a certain advantage when materials with low water content are processed.

Embodiment 13: A fifth circulating mill main engine is the fourth circulating mill main engine according to Embodiment 12 from which the kinetic energy recovery device is removed.

Embodiment 14: A sixth circulating mill main engine is composed of a primary mill, a secondary mill, and an inner circulation pipe, the primary mill is the second circulating mill according to Embodiment 2, the secondary mill is the third circulating mill according to Embodiment 3, an outlet of the primary mill is connected to an inner circulation pipe interface of the secondary mill through the inner circulation pipe, an outlet of the secondary mill is connected to an inner circulation pipe interface of the primary mill through the inner circulation pipe, an inlet of the primary mill is an inlet of the sixth circulating mill main engine, and an inlet of the secondary mill is an outlet of the sixth circulating mill main engine.

The sixth circulating mill main engine and the second circulating mill main engine are basically the same in structure, but are different in that the secondary mill of the sixth circulating mill main engine is the third circulating mill according to Embodiment 3, while the secondary mill of the second circulating mill main engine is the second circulating mill according to Embodiment 2. The rotation of the secondary mill of the sixth circulating mill main engine can be completely driven by the air flow from the outlet of the primary mill. In order to achieve this objective, the power recovery impeller of the secondary mill is the third kinetic energy recovery impeller of which the diameter of the power recovery impeller is 0.5 to 4 times that of the impeller according to Embodiment 7. In this embodiment, the circulating mill main engine thus has the highest kinetic energy recovery efficiency, can reduce the energy consumption of the existing mineral mill by more than 30%, and has obvious advantages in large-scale grinding processing such as minerals, cement, sludge, and forage grass.

A circulation channel in the first circulating mill main engine composed of a primary mill, an inner circulation pipe, a secondary mill, and an inner circulation pipe, circulation channels in the second, third, and sixth circulating mill main engines composed of a primary mill, an inner circulation pipe, a secondary mill feed pipe, a secondary mill, an inner circulation pipe, and a primary mill feed pipe, and circulation channels in the fourth and fifth circulating mill main engines composed of a circulating mill, an inner circulation pipe, a feed pipe, and a three-way air inlet are referred to as inner circulation channels, which are main places for the circulating mill to carry out grinding and drying.

In addition to implementing the kinetic energy recovery and utilization of high-speed fluidized materials in the inner circulation channels to reduce the circulating energy consumption of a circulating fluidized bed, the technical solutions of the first, second, and sixth circulating mill main engines also lay the foundation for solving the key problem of processing high-humidity and high-viscosity materials in the circulating fluidized bed, i.e., the wall hanging problem. Practice has proved that an air flow velocity at an outlet of a common centrifugal fan, equivalent to the lowest flow velocity of the fluidized materials in the inner circulation channels, has been able to form an effective impact on the materials adhered in the inner circulation channels to make them fall off, and then continuous impact is sufficient to ensure that most materials with moisture content below 60% do not form wall hangings. A curved circulation channel is a place where wall hanging is most serious. The circulating mill main engine uses a structure form of primary and secondary mills, which creates a condition for straightening the inner circulation pipe.

Relatively, due to the space limitation of the kinetic energy recovery device, the first circulating mill has a worse kinetic energy recovery effect than the second, fourth, and sixth circulating mills.

Embodiment 15: A seventh circulating mill main engine is a circulating mill main engine composed of one primary mill and a plurality of secondary mills. The primary mill is the second circulating mill, and the secondary mills may be the second or third circulating mill. Referring to FIG. 11, in the upper left part, a housing of a primary mill 75 is provided with two outlets respectively connected to inner circulation pipe interfaces on feed pipes of a secondary mill 76 and a secondary mill 77 through inner circulation pipes. A feed pipe of the primary mill is provided with two inner circulation pipe interfaces respectively connected to outlets of the two secondary mills through inner circulation pipes. In the lower middle part, a housing of a primary mill 80 is provided with three outlets respectively connected to inner circulation pipe interfaces on feed pipes of a secondary mill 78, a secondary mill 79, and a secondary mill 81 through inner circulation pipes. A feed pipe of the primary mill 80 is provided with three inner circulation pipe interfaces respectively connected to outlets of the three secondary mills through inner circulation pipes. In the upper right part, a housing of a primary mill 85 is provided with four outlets respectively connected to inner circulation pipe interfaces on feed pipes of a secondary mill 82, a secondary mill 83, a secondary mill 84, and a secondary mill 86 through inner circulation pipes. A feed pipe of the primary mill 85 is provided with four inner circulation pipe interfaces respectively connected to outlets of the four secondary mills through inner circulation pipes.

The seventh circulating mill main engine in this embodiment is a transformation of the second and sixth circulating mill main engines. The second and sixth circulating mill main engines are used in occasions of large mills, and have problems such as too high pressure in the primary mill, a too long flow channel, and large energy consumption, as well as unbalanced impact of fluidized materials from the outlet of the secondary mill on the kinetic energy recovery impeller of the primary mill, while the seventh circulating mill main engine in this embodiment solves the above problems.

Embodiment 16: For a variety of feed pipes of the circulating mill, an important function of the feed pipe of the circulating mill is grading, and feed pipes of different structures have different grading capabilities. The common feed pipe may be in following forms: a straight pipe with one end connected to an air inlet on the housing of the secondary mill and the other end being an outlet of the circulating mill main engine; or a tapered pipe with a small head connected to an air inlet on the housing of the secondary mill and a large head provided with a cover, an opening in the middle of the cover being an outlet of the circulating mill main engine; or a tapered pipe with a small head connected to an air inlet on the housing of the secondary mill and a large head being an outlet of the circulating mill main engine; or a tapered pipe with a large head connected to an air inlet on the housing of the secondary mill and a small head being an outlet of the circulating mill main engine; or a cyclone dust collector, of which an air inlet is an inner circulation pipe interface, an ash discharge port is connected to an air inlet on the housing of the secondary mill, and an exhaust outlet is an outlet of the circulating mill main engine; or an uncapped cyclone dust collector, of which an air inlet is an inner circulation pipe interface, an ash discharge port is connected to an air inlet on the housing of the secondary mill, and an uncapped end is an outlet of the circulating mill.

Embodiment 17: First and second operation medium supply branches, referring to FIG. 12, each are composed of a heat exchanger, a condenser 94, and a heater 97. The heat exchanger is composed of a heat exchange branch 93 and a cooling branch 92, heat medium channel air inlets of the heat exchange branch 93 and the cooling branch 92 are gathered together through a heat exchanger air inlet pipe 90, an inlet of the heat exchanger air inlet pipe is the air inlet 91 of the operation medium supply branch, heat medium channel exhaust outlets of the heat exchange branch and the cooling branch are connected to an air inlet of the condenser 94, an exhaust outlet of the condenser is connected to an inlet of a refrigerant channel of the heat exchange branch 93 through a condenser exhaust pipe 95, an exhaust outlet of the refrigerant channel of the heat exchange branch 93 is connected to an air inlet of the heater 97 through a refrigerant channel exhaust pipe 98, and an exhaust outlet of the heater is an exhaust outlet 96 of the operation medium supply branch.

The second operation medium supply branch is formed by disposing heat medium channel air intake volume adjusting devices of the heat exchange branch and the cooling branch in the heat exchanger air inlet pipe of the first operation medium supply branch, which can adjust an air volume ratio between the two heat medium channels of the heat exchange branch and the cooling branch.

This embodiment further improves the operation medium supply branch in the early stage of the project, intended to provide a cheap operation medium in line with process requirements for the circulating mill, to dehumidify tail gas discharged from the circulating mill and then heat it to be recycled as an intake air flow, to provide economic feasibility for the use of special operation mediums such as nitrogen, and also to achieve the collection of water rich in volatile components of the materials in the form of liquid. The humidity in the tail gas discharged from the circulating mill is very high. During cooling, both sensible heat and latent heat are released, and the cold air discharged from the condenser can absorb only the sensible heat. As a result, the cooling load of the condenser of the operation medium supply branch in the early stage is too large and the economy is not good enough. In this embodiment, the heat exchanger is divided into a heat exchange branch and a cooling branch, a heat medium channel air intake volume adjusting device is used to adjust an air intake volume of the heat exchange branch to make the heat released by cooling of the air flow in the heat medium channel match the heat absorbed by the cold air in the refrigerant channel. Then, the evaporator of the heat pump is used to supply cooling for the condenser and the condenser of the heat pump is also used to supply heat for the heater. Under a configuration condition of 20° C. natural wind or natural water as the refrigerant of the cooling branch, the energy efficiency ratio of more than 7:1 can be achieved theoretically in this embodiment, which provides a cheap operation medium in line with process requirements for the circulating mill.

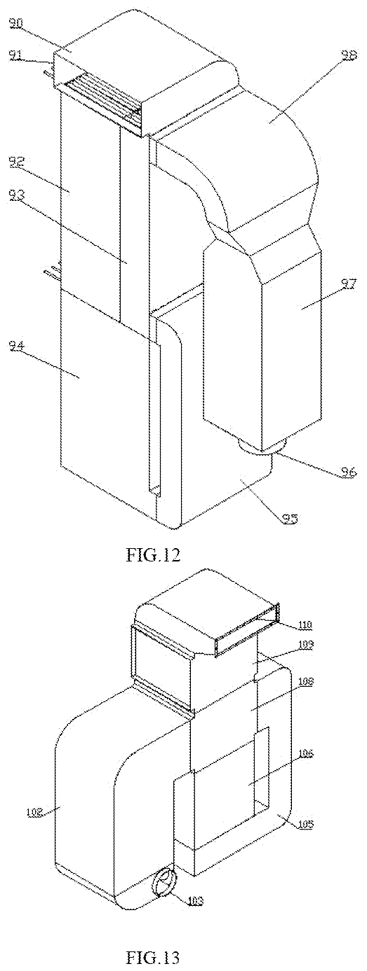

Embodiment 18: A third operation medium supply branch, referring to FIG. 13, is composed of a first heat exchanger 109, a second heat exchanger 108, a condenser 106, and a heater 102. A heat medium channel inlet of the first heat exchanger 109 is an air inlet 110 of the operation medium supply branch, an outlet of the heater 102 is an exhaust outlet 103 of the operation medium supply branch, an air flow channel of the operation medium supply branch is formed by the heat medium channel of the first heat exchanger 109, a heat medium channel of the second heat exchanger 108, a heat medium channel of the condenser 106, an air duct 105, a refrigerant channel of the second heat exchanger 108, and a refrigerant channel of the heater 102 connected sequentially, a refrigerant channel of the condenser 106 is an evaporator of a heat pump, and a heat medium channel of the heater 102 is a condenser of the heat pump.

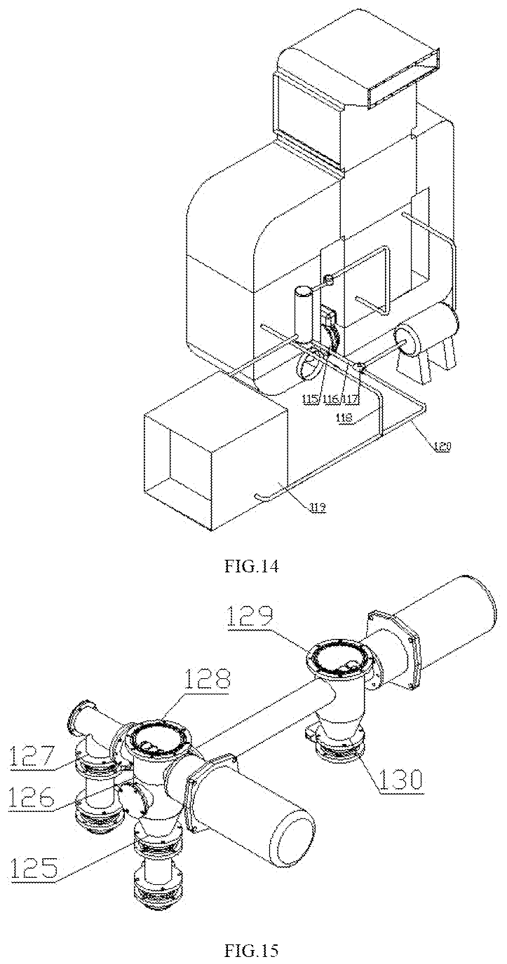

Embodiment 19: A fourth operation medium supply branch, referring to FIG. 14, is improved based on the third operation medium supply branch according to Embodiment 18. A compressor exhaust pipe of the heat pump is provided with a switching valve 117 to divide the exhaust pipe into two branches. A first branch 116 enters the heater and then leads to a radiator 119, a second branch 120 is in communication with a first branch 108 coming out of the heater, and the air duct is provided with a pipeline 115 with valves connected to the outlet of the heater.

When the circulating mill is configured to process dry materials with low moisture content, such as dry notoginseng, since there is no heat consumed by water vaporization, the heat into which the kinetic energy of the impeller is converted may increase the temperature in the machine, which is not conducive to the processing of heat-sensitive materials. This embodiment may significantly adjust the temperature of the operation medium supplied by the operation medium supply branch according to process requirements.

When natural air is used as the operation medium, the circulating mill may also be provided with only a heater or a cooler to heat or cool the operation medium, and an exhaust outlet of the heater or the cooler is connected to the air inlet of the outer circulation pipe.

Embodiment 20: A return device of the circulating mill, referring to FIG. 15, is composed of a 1# conveyor and a 2# conveyor. The 1# conveyor is provided with one feed port 128 and two discharge ports, one discharge port is a main discharge port 127 of the circulating mill, the 2# conveyor is provided with two feed ports and two discharge ports, the feed port of the 1# conveyor is connected to an ash discharge port of the bag dust collector, the other discharge port 126 of the 1# conveyor is connected to one feed port of the 2# conveyor, the other feed port 129 of the 2# conveyor is connected to the cyclone dust collector ash discharge port, one discharge port 130 of the 2# conveyor is provided with a valve, an outlet of the valve is connected to the cyclone dust collector ash discharge interface on the outer circulation pipe, and the other discharge port of the 2# conveyor is an auxiliary discharge port 125 of the circulating mill. The main discharge port and the auxiliary discharge port of the circulating mill may be further provided with an air-closing device formed by a valve, a storage pipe, and a valve connected successively, to prevent a large amount of leakage of the operation medium from the discharge port during discharging.

One of the difficulties that the circulating Mill faces in processing high-humidity and high-viscosity materials is that the materials adhere to machine parts, namely, wall hanging. An effective solution is to reduce the moisture content of the materials. The return device of the circulating mill reduces the moisture content of the material in the machine with a method of preferentially sending powder collected by the bag dust collector back to the circulating mill main engine through the 2# conveyor. In this way, even if it is liquid, wall hanging can be completely eliminated by adjusting the feeding amount and the return amount. On the basis of the impact and peeling effects of high-speed fluidized materials in the inner circulation channel inherent to the circulating mill main engine, the circulating mill theoretically solves the problem of wall hanging of drying and powder-making of the high-humidity and high-viscosity materials. When materials with good fluidity and dispersity are processed and requirements on the fineness or moisture content of the products are not high, the materials collected by the cyclone dust collector can be discharged from the auxiliary discharge port by inverting the return device.

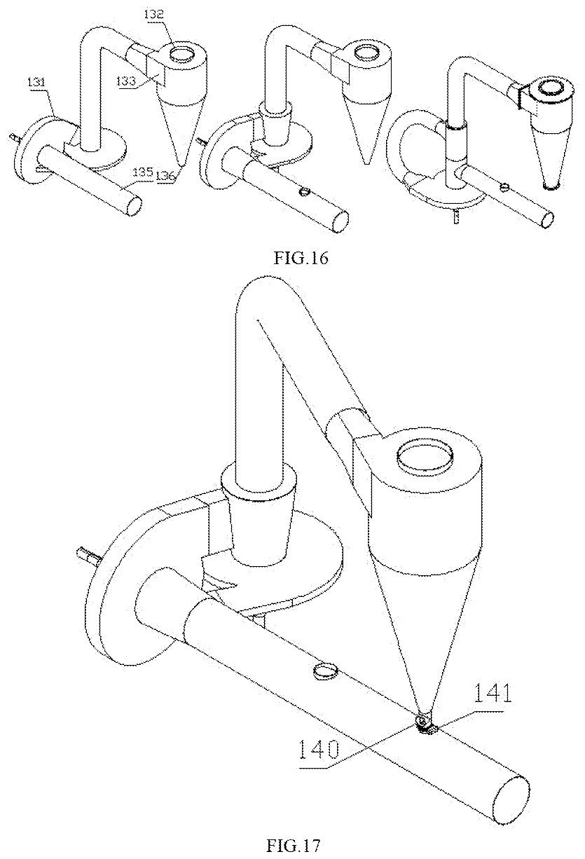

Embodiment 21: A first circulating mill, referring to FIG. 16, is composed of a circulating mill main engine 131 and a first accessory device. The first accessory device is composed of a dust collector 133 and an outer circulation pipe 135. An air inlet of the dust collector 133 is connected to an outlet of the circulating mill main engine, a dust collector exhaust outlet 132 is an exhaust gas outlet, a dust collector ash discharge port 136 is a discharge port, and an outlet of the outer circulation pipe is connected to an inlet of the circulating mill main engine. The circulating mill main engine shown on the left of FIG. 6 is the first circulating mill main engine, the circulating mill main engine shown in the middle is the second or third or sixth circulating mill main engine, and the circulating mill main engine shown on the right is the fourth or fifth circulating mill main engine. The outer circulation pipe in this embodiment may be further provided with a first screw feeder.

In the circulating mill according to this embodiment, due to the opening of the outer circulation channel, the moisture and particle size of a product are completely determined by grading performance of the circulating mill main engine, and thus the circulating mill is suitable for occasions such as sludge and fertilizer processing with low requirements on the moisture content and particle size of the product.

Embodiment 22: A second circulating mill, referring to FIG. 17, is improved based on the equipment in Embodiment 21. The outer circulation pipe is provided with a dust collector ash discharge interface provided with an adjusting valve 141. A dust collector ash discharge pipe is provided with a discharge port 140, and the adjusting valve 141 is connected to a dust collector ash discharge port.

Compared with Embodiment 21, this embodiment can control the moisture content and particle size of a product by adjusting the discharge amount and the discharge time through the adjusting valve.

Embodiment 23: A third circulating mill, referring to FIG. 18, is improved based on the equipment in Embodiment 21. The outer circulation pipe is provided with a cyclone dust collector ash discharge interface 146. The dust collector in Embodiment 21 is replaced with a cyclone dust collector 147. A bag dust collector 144 is added. An inlet of the cyclone dust collector 147 is connected to an outlet of the circulating mill main engine. An air outlet of the cyclone dust collector 147 is connected to an inlet of the bag dust collector 144. An ash discharge port of the cyclone dust collector 147 is connected to the cyclone dust collector ash discharge interface 146 on the outer circulation pipe. A bag dust collector exhaust outlet is an exhaust air outlet 143, and a bag dust collector ash discharge port is a discharge port 145.

Due to the use of two-stage separation and the implementation of external circulation, the moisture content of the product processed by the equipment in this embodiment can be as low as 1% and the particle size is less than 800 meshes. In addition, since the powder discharged from the ash discharge pipe of the cyclone dust collector returns to the circulating mill main engine with the air flow, the moisture content of the materials is reduced and the dispersity and fluidity of the material are greatly improved.

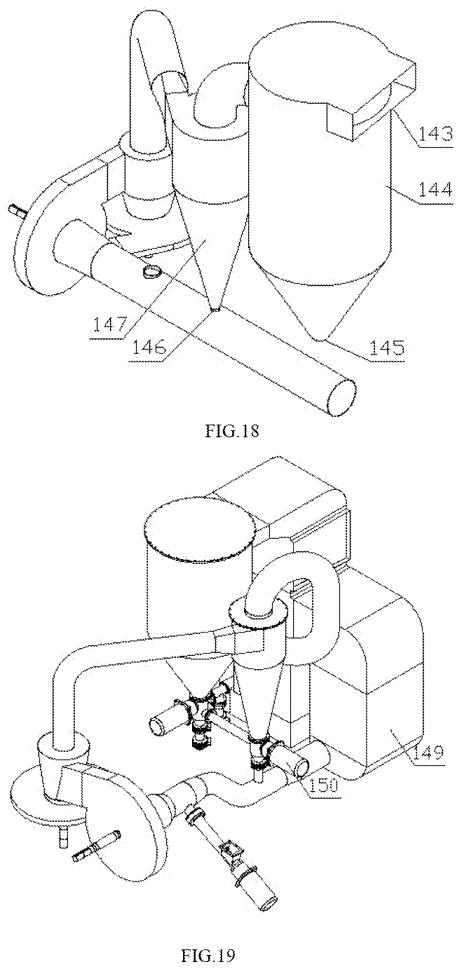

Embodiment 24: A fourth circulating mill, referring to FIG. 19, is formed by adding an operation medium supply branch 149 and a return device 150 based on the equipment in Embodiment 23. A bag dust collector exhaust outlet is connected to an air inlet of the operation medium supply branch, and an air inlet of an outer circulation pipe is connected to an exhaust outlet of the operation medium supply branch. In this embodiment, the air purification chamber of the bag dust collector of the circulating mill may be further provided with a second exhaust outlet including a cover, and the outer circulation pipe may be further provided with a second air inlet including a cover, so as to facilitate the use of natural air as the operation medium.

When the equipment according to this embodiment uses a heat pump as a heat source and a cold source of the operation medium supply branch, in theory, the energy consumption of the whole machine in terms of drying and powder-making of materials with moisture content of 60% can be reduced to 0.5 KWH/KG dry powder, and the moisture content of most fresh agricultural products is about 90%. For low-value forage materials such as fresh corn stalk, it is not economically feasible to directly use the circulating mill for processing. However, even low-value agricultural products become economically feasible by reducing moisture to less than 60% by good economic squeezing dehydration and then processing them with the circulating mill. Since the operation medium is recycled, the full closed circuit process in this embodiment adopting a special operation medium has good economy, which creates conditions for the processing of materials that are flammable, explosive, toxic, and need to inhibit chemical changes. In addition, the equipment according to this embodiment is also actually economical to collect or recycle the moisture in the materials in a form of liquid and thus can be used as a distillation device. For plant materials, the water collected by the equipment is actually cell fluid. The cell fluid is of great value because it is rich in volatile components of plants, which can be further processed into spices such as rose essential oil and pharmaceuticals such as volatile oils in notoginseng.

Compared with the above inner circulation channel, in this project, a circulation channel composed of a circulating mill main engine, a cyclone dust collector, and an outer circulation pipe is referred to as an outer circulation channel, a circulation channel composed of a bag dust collector, a return device, an outer circulation pipe, a circulating mill main engine, and a cyclone dust collector is referred to as a return channel, and a channel composed of an operation medium supply branch, an outer circulation pipe, a circulating mill main engine, a cyclone dust collector, and a bag dust collector is referred to as a tail gas circulation channel.

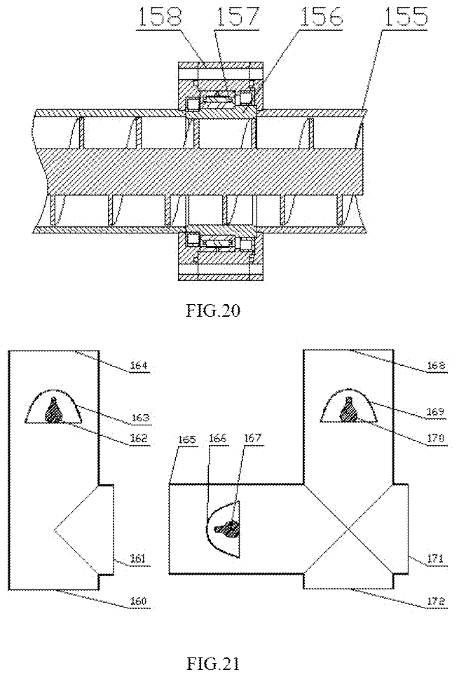

Embodiment 25: The circulating mill adopts a screw feeder. Referring to FIG. 20, a discharge port 155 is at a tail end of a material pipe of the screw feeder, a tail end bearing inner ring 157 is fixed to a screw blade through a bearing sleeve 156, and a tail end bearing seat 158 is fixed to the material pipe. A feeding port of the screw feeder may be further provided with an air-closing device formed by a valve, a storage pipe, and a valve connected successively, so as to prevent a large amount of leakage of the operation medium from the feeding port during feeding.

Embodiment 26: An optical device and an acoustic device. Referring to FIG. 21, on the left is a first or second optical device composed of a tee joint, a light source 162, a reflector 163, and a dust-proof fan. An opening 160 of the tee joint is connected to the outlet of the circulating mill main engine or the exhaust outlet of the cyclone dust collector, a second opening 161 is connected to the air inlet of the cyclone dust collector or the bag dust collector, the light source 162 is disposed in a third opening of the tee joint, the third opening of the tee joint is connected to an exhaust outlet of the dust-proof fan, an inlet of the dust-proof fan is in communication with an air purification chamber of the bag dust collector, and the reflector 163 is configured to concentrate light on fluidized materials. On the right is a third or fourth optical device composed of a cross joint, a light source, a reflector, and a dust-proof fan. An opening 172 of the cross joint is connected to the outlet of the circulating mill main engine or the exhaust outlet of the cyclone dust collector, a second opening 171 is connected to the air inlet of the cyclone dust collector or the bag dust collector, the light source 167 is disposed in a third opening of the cross joint, the reflector 166 is configured to concentrate light of the light source 167 on fluidized materials, the light source 170 is disposed in a fourth opening of the cross joint, and the reflector 169 is configured to concentrate light of the light source 170 on the fluidized materials. The light of the third and fourth optical devices can simultaneously illuminate incoming and outgoing directions of the fluidized materials, and the effect is better than that of the first optical device. A fifth optical device is a light source disposed in the air inlet of the outer circulation pipe and a reflector, a sixth optical device is a light source disposed in the exhaust outlet of the bag dust collector, and a seventh optical device is a light source disposed in the operation medium supply branch where liquid water converges.

By choosing light sources of different wavelengths, the optical device can be used to sterilize the fluidized materials by ultraviolet, trigger the photochemical reaction of the materials to degrade chlorophyll and harmful components, and promote the generation of beneficial components. The applicant's early Chinese invention patent 2013107484148 adopts a method of disposing an ultraviolet sterilization lamp in the circulation channel to sterilize fluidized materials. As powder may adhere to the surface of the lamp to block light, the sterilization effect is greatly reduced. In this embodiment, the first, second, third, and fourth optical devices solve the problems by preventing the powder from adhering to the surface of the light source through the air flow introduced by the dust-proof fan, there is no dust in the air inlet of the outer circulation pipe, the exhaust outlet of the bag dust collector, the exhaust outlet of the condenser, and the operation medium supply branch, and the light transmittance of gaseous and liquid materials is good, so that they are ideal places for use of optical devices.

The acoustic device is configured to trigger physical and chemical reactions of materials in the machine. The acoustic device is a sound generator disposed on the circulating mill main engine and/or the accessory device. When the sound generator is an ultrasonic generator, it can assist in cleaning the equipment, heat and sterilize materials in the machine, or vibrate to promote physical and chemical reactions, and the like.

Embodiment 27: A large mine circulating mill is composed of the sixth circulating mill main engine according to Embodiment 14 and an accessory device. The secondary mill is the third circulating mill according to Embodiment 3, the kinetic energy recovery impellers of the primary mill and the secondary mill are the third kinetic energy recovery impeller according to Embodiment 6, the diameter of the kinetic energy recovery impeller is 1.2 times that of the impeller, the accessory device is the third accessory device, and the outer circulation pipe is provided with a large hard material mill for pre-crushing.

Embodiment 28: An application method of the circulating mill and products processed by same.

The circulating mill has a variety of configuration manners, which can meet processing requirements of different materials, and a typical configuration manner is as follows:

A first configured circulating mill is the fourth circulating mill, and a circulating mill main engine is the second circulating mill main engine.

A second configured circulating mill is the fourth circulating mill, a circulating mill main engine is the second circulating mill main engine, and an accessory device is provided with the third feeding device.

A third configured circulating mill is the first circulating mill, and a circulating mill main engine is the fourth circulating mill main engine.

A fourth configured circulating mill is the fourth circulating mill, a circulating mill main engine is the second circulating mill main engine, and an accessory device is provided with the second feeding device, the second return device, and the fourth operation medium supply branch.

A fifth configured circulating mill is the fourth circulating mill, a circulating mill main engine is the sixth circulating mill main engine, primary and secondary mills are provided with the third kinetic energy recovery impeller of which the diameter is 0.5 to 4 times that of the impeller, and an accessory device is provided with the fifth operation medium supply branch.

A sixth configured circulating mill is the fourth circulating mill, a circulating mill main engine is the sixth circulating mill main engine, primary and secondary mills are provided with the third kinetic energy recovery impeller of which the diameter is 0.5 to 4 times that of the impeller, and an accessory device is provided with a mill for grinding large hard materials.

(1) A processing method of plant fresh fruit powder and plant fresh fruit powder processed by same. The method is performed according to following steps: S1: washing fresh plants; and S2: adding materials treated in S1 into the first configured circulating mill to make dry powder. Plant fresh fruit powder is processed using the method.

(2) A method for spray drying by using a circulating mill and powder processed by same. The method includes adding materials to the second configured circulating mill, and obtaining made dry powder collected and discharged by the bag dust collector. Powder prepared by spray drying is the powder processed using the method.

(3) A processing method of feedstuff and a product processed by same. The method is performed according to following steps: S1: preparation of raw material powder: adding feeding raw materials into the fifth configured circulating mill for processing to obtain dry feeding raw material powder; and S2: preparation of feedstuff: making the feeding raw material powder obtained in S1 into feedstuff. Feedstuff is the feedstuff processed using the method.

(4) A method for improving nutrient output of cultivated land and agricultural powder produced therefrom. The method is performed according to following steps: S1: seed selection: selecting suitable crop varieties based on unit yield, crop growth period, and plant nutrient content; S2: determination of the harvest time: determining the harvest time by maximizing “the harvest times in a year×nutrient yield per unit area”; the nutrient yield per unit area being the total amount of nutrients in the crop plant obtained from the previous harvest per unit planting area; S3:management measures: timely harvesting and timely sowing; S4: processing: S401: squeezing and dewatering: reducing the water content of harvested crops to less than 70% by squeezing and dewatering; S402: drying and powder-making: making the materials obtained in S401 into powder by using the fifth configured circulating mill; and S5: utilization: using the powder processed in S4 as raw food materials or feedstuff. Agricultural powder is the powder produced using the method.

(5) A pharmaceutical with volatile components as functional ingredients and a method for preparation and development thereof. The method is performed according to following steps: S1: large-scale preparation of volatile components: adding raw materials to the fourth configured circulating mill, and condensing, by the operating medium supply branch, gasified volatile components in the materials into liquid for discharge, so as to obtain liquid materials rich in volatile components; S2: separating and purifying the liquid materials rich in volatile components made in S1, to obtain materials with medicinal value; and S3: making the materials with medicinal value made in S2 into drugs, or studying the materials with medicinal value made in S2, and developing new drugs. A pharmaceutical with volatile components as functional ingredients is the pharmaceutical made or developed using the method.

(6) A method of simultaneously preparing volatile components in powder and powder feedstock and a product processed by same. The preparation method includes adding raw materials to the fourth configured circulating mill, collecting processed powder by a bag dust collector, changing the volatile components in the materials into a gaseous state during processing, and condensing, by the operation medium supply branch, the gaseous volatile components into liquid materials. The product is the powder or liquid volatile components processed using the method.

(7) A method for extracting volatile components from materials and a product processed by same. The method is performed according to following steps: adding raw materials to the fourth configured circulating mill, and condensing, by the operation medium supply branch, gaseous materials formed by gasification of the volatile components into liquid materials. A volatile component is the material made using the method.

(8) A preparation method of a plant dew beverage and a product processed by same. The method is performed according to following steps: S1: preparation of plant dew: removing impurities from fresh plants, washing them and adding them to the fourth configured circulating mill, and condensing, by the operation medium supply branch, gaseous water and gaseous volatile components formed by gasification of water and volatile components in the materials into liquid to obtain plant dew; and S2: beverage production: processing the plant dew obtained in step S1 into a plant dew beverage; or separating unneeded components from the plant dew obtained in step S1 to make a plant dew beverage.

(9) A crude oil distillation method and a product processed by same. The method is performed according to following steps: adding crude oil to the second configured circulating mill, and condensing, by the operation medium supply branch, gasified volatile components in the crude oil into liquid to obtain distillate. The product is the crude oil distillate prepared using the method.

(10) A method for producing sulfur-free konjac powder and a product processed by same. The method is performed according to following steps: S1: pre-processing of commodity fresh konjac: S101: washing and peeling; S102: cutting: cutting the konjac treated in S101 into pieces, wherein the pieces need not be regular, but the konjac with defects of bud eyes, insect holes, different color spots, plant root spots, root holes and wormholes is cut together, and the konjac without defects is cut together; S103: grading: grading the cut konjac pieces while the konjac is cut into pieces, with the defective ones as one grade and the non-defective ones as another grade; S104: squeezing and dewatering: reducing the water content of the konjac pieces graded in S103 to less than 75% by squeezing and dewatering; S2: customization of an operation medium: adjusting the operation medium to include an oxygen component of less than 10%; and S3: drying and powder-making: adding the konjac pieces of two grades processed in S1 to the fourth configured circulating mill to make sulfur-free konjac powder. Sulfur-free konjac powder is the konjac powder produced using the method.

(11) A method for producing starch and a product processed by same. The method is performed according to following steps: S1: pre-processing: removing impurities from raw materials and washing the raw materials; S2: drying and powder-making: adding the materials processed in step S1 to the first configured circulating mill to make powder; S3: starch separation: mixing the powder made in S2 with water for full agitation, and separating the starch after settling to obtain wet starch; and S4: adding the wet starch obtained in S3 to the fourth configured circulating mill for drying to obtain starch. Plant starch is the starch made using the method.

(12) A processing and utilization method of fertilizers and a product processed by same. The method is performed according to following steps: S1: preparation of fertilizer raw materials: making raw materials into powder by using the first configured circulating mill to obtain fertilizer raw material powder; or adding raw materials and other ingredients to the third configured circulating mill to make them into powder to obtain fertilizer raw material powder; and S2: utilization: using the fertilizer raw materials processed in step S1 as fertilizers; or processing the fertilizer raw material powder processed in step S2 into fertilizers. A fertilizer is the fertilizer made using the method.

(13) A preparation method for barley seedling powder and a product processed by same. The method is performed according to following steps: S1: pre-processing: removing impurities from harvested fresh barley seedlings and washing them; and S2: drying and powder-making: adding the barley seedlings processed in step S1 to the fourth configured circulating mill to make them into powder. Barley seedling powder is the barley seedling powder made using the method.

(14) A processing method for hemp seed protein powder and a product processed by same. The method is performed according to following steps: S1: pre-processing: shelling hemp seed for oil manufacture; and S2: preparation of protein powder: making the materials processed in S1 into powder by using the fourth configured circulating mill. Hemp seed protein powder is the hemp seed protein powder processed using the method.

(15) A processing and utilization method of hemp stem powder and a product. The method is performed according to following steps: S1: pre-processing: cutting hemp stem; or pre-crushing hemp stem into a length of 200 mm, and peeling the hemp stem; or peeling hemp stem and then pre-crushing the hemp stem into a length of 200 mm; S2: preparation of hemp stem powder: making the materials treated in S1 into powder by using the third configured circulating mill to obtain hemp stem powder; S3: utilization of hemp stem powder: pressing the hemp stem powder processed in S2 into profiles; or using the hemp stem powder processed in S2 as toothpaste fillers; or adding excipients to the hemp stem powder processed in S2 and pressing them to make profiles. Hemp stem powder is processed using the method. A profile is processed using the method. A toothpaste filler is the toothpaste filler processed using the method.

The water content of the hemp stem is not high, and the wall hanging problem may not occur during processing by the fourth configured circulating mill.

(16) A method for primary processing of hemp flower and leaf in a production area and a product processed by same. The method includes drying and pulverizing fresh hemp flower and leaf by using the fourth configured circulating mill to obtain hemp flower and leaf powder. Hemp flower and leaf powder is the hemp flower and leaf powder made using the method.

(17) A preparation method for dry granulation raw material powder and a product processed by same. The method includes adding raw materials to the fourth configured circulating mill to simultaneously complete grinding, mixing, and drying to obtain raw material powder required by dry granulation. Dry granulation raw material powder is the product processed using the method.

(18) A processing method of fish powder and a product processed by same. The method includes adding fresh fish to the fourth configured circulating mill to make powder. Fish powder is the fish powder processed using the method.

(19) A processing method of feeding bone powder and a product processed by same. The method includes adding fresh bone to the fourth configured circulating mill to make powder. Feeding bone powder is the product processed using the method.

(20) A preparation method of extract and a product processed by same. The method includes following steps: S1: preparation of raw material powder: making fresh raw materials into powder by using the fourth configured circulating mill; S2: preparing an extracting solution, S201: mixing the powder obtained in S1 with a solvent to dissolve extract, to obtain mixture slurry of an extracting solution and slag; S202: separation of the slag and the extracting solution: separating the mixture slurry made in S201 to obtain the extracting solution and the slag; S203: extraction of residual extract from slag: mixing the slag obtained in S202 with a solvent to dissolve residual extract in the slag, to obtain mixture slurry of an extracting solution and slag; separating the slag and the extracting solution by using the method in S202; repeating step S203, till the residual extract in the slag is no longer economically valuable to extract; S204: purification of the extracting solution: removing impurities from the extracting solution and purifying the extracting solution; S3: drying of the extracting solution: drying the extracting solution made in S2 by using the second configured circulating mill to obtain extract; and S4: drying of the slag: making the slag made in S2 into powder by using the fourth configured circulating mill. Extract is the extract made using the method.

(21) A processing method of forage grass and a product processed by same. The method includes making fresh forage grass or forage grass naturally dried for 1 to 5 days into powder by using the fifth configured circulating mill. Forage grass powder is the forage grass powder processed using the method.

(22) A preparation method of mineral powder and a product processed by same. The method is performed according to following steps: adding raw mineral materials to the sixth configured circulating mill through a feeding port of a mineral mill, pre-crushing, by the mill, the materials into coarse powder, driving, by an air flow in an outer circulation pipe, the coarse powder into the circulating mill main engine to be further crushed into fine powder, collecting fine powder with a required particle size separated out and entering a bag dust collector with the air flow to obtain mineral powder. Mineral powder is the mineral powder prepared using the method.

(23) A preparation method of perfume using plant aroma as functional components and a product processed by same. The method is performed according to following steps: S1: preparation of cell fluid: adding fresh plants to the fourth configured circulating mill for processing, and condensing, by the operation medium supply branch, gaseous water and gaseous volatile components formed by gasification of water and volatile components in the materials to obtain cell fluid; and S2: preparation of perfume: making the cell fluid obtained in S2 into perfume. Perfume is the perfume made using the method.

(24) A preparation method of fresh corn flour and a product processed by same. The method includes: S1: harvesting fresh corn and choosing fresh and tender corn to harvest; S2: shelling and threshing: shelling and threshing the fresh tender corn harvested in step S1 to obtain fresh corn kernels; and S3: preparation of fresh corn flour: adding the fresh corn kernels prepared in step S2 to the fourth configured circulating mill to make fresh corn flour. Fresh corn flour is the fresh corn flour made using the method.

(25) A preparation method of fresh bean flour and a product processed by same. The method includes: S1: harvesting fresh beans and choosing fresh beans near the end of a grain-filling period to harvest; S2: shelling: shelling the fresh beans harvested in step S1 to obtain fresh bean kernels; and S3: preparation of fresh bean flour: adding the fresh bean kernels prepared in step S2 to the fourth configured circulating mill to make fresh bean flour. Fresh bean flour is the fresh bean flour made using the method.

(26) A preparation method of fresh wheat flour and a product processed by same. The method includes: S1: harvesting fresh wheatears and choosing fresh wheatears near the end of a grain-filling period to harvest; S2: shelling: shelling the wheatears harvested in step S1 to obtain fresh wheat grains; and S3: preparation of fresh wheat flour: adding the fresh wheat grains prepared in step S2 to the fourth configured circulating mill to make fresh wheat flour. Fresh wheat flour is the fresh wheat flour made using the method.

(27) A preparation method of fresh rice flour and a product processed by same. The method includes: S1: harvesting rice and choosing rice near the end of a grain-filling period to harvest; S2: preparation of rice milk: removing rice milk from the rice harvested in step S1; and S3: drying of the rice milk: adding the rice milk prepared in step S2 to the fourth configured circulating mill to make fresh rice flour. Fresh rice flour is the fresh rice flour made using the method.

(28) A preparation method of potato powder and a product processed by same. The method includes: controlling the oxygen content of an operation medium to less than 8%, washing, peeling or unpeeling potatoes, and adding the potatoes to the fourth configured circulating mill to make dry powder. Potato powder is the potato powder made using the method.

(29) A preparation method of pumpkin powder and a product processed by same. The method includes: washing and peeling pumpkin, removing pulp, and adding the pumpkin to the fourth configured circulating mill to make dry powder. Pumpkin powder is the pumpkin powder made using the method.

(30) A preparation method of tomato powder. The method includes: washing fresh tomatoes, and adding the tomatoes to the fourth configured circulating mill to make dry powder. Tomato powder is the tomato powder made using the method.

The same method can also be used to prepare green onion powder, ginger powder, cucumber powder, watermelon powder, pepper powder, garlic bolt powder, cabbage powder, bitter cabbage powder, carrot powder, tea powder, edible rose powder, coffee powder, and other edible powder.

(31) A preparation method of rose cell fluid and a product processed by same. The method includes: adding rose to the fourth configured circulating mill, and condensing, by the operation medium supply branch, vaporized moisture and rose scent into liquid. Rose cell fluid is the rose cell fluid made using the method.

The same method can also be used to prepare cell fluid of fresh agricultural products such as garlic, apple, cantaloupe, and Chinese herbal medicines.

(32) A preparation method of fresh maca powder and maca glucosinolates and a product processed by same. The method is performed according to following steps: S1: washing fresh maca and adding the maca to the fourth configured circulating mill; S2: collecting fresh maca powder by the bag dust collector, and collecting maca cell fluid by the operation medium supply branch; and S3: purifying the maca cell fluid obtained in S2 to obtain maca glucosinolates. Fresh maca powder is made using the method. A maca glucosinolate is the maca glucosinolate made using the method.

(33) A preparation method of instant coffee and instant coffee processed by same. The method includes: S1: preparation of coffee powder: adding fresh or dried coffee beans to the fourth configured circulating mill to make dry powder; S2: preparation of coffee liquid: adding the coffee powder obtained in S1 to water, to dissolve soluble components in the coffee powder into the water to obtain mixture slurry of coffee liquid and coffee grounds, and filtering the mixture slurry to obtain the coffee liquid; S3: drying and powder-making of the coffee liquid: adding the coffee liquid obtained in S2 to the second configured circulating mill to make dry powder to obtain instant coffee. Instant coffee is the instant coffee made using the method.

(34) A preparation method of milk powder and a product processed by same. The method includes: adding emulsion to the second configured circulating mill to make milk powder. Milk powder is the milk powder made using the method.

(35) A preparation method of soybean milk powder and a product processed by same. The method includes: adding soybean milk to the second configured circulating mill to make soybean milk powder. Soybean Milk powder is the milk powder made using the method.

(36) A preparation method of Chinese herbal medicine powder and Chinese herbal medicine cell fluid and a product processed by same. The method includes: washing Chinese herbal medicines and adding them to the fourth configured circulating mill, discharging dry Chinese herbal medicine powder from a main discharge port, and collecting Chinese herbal medicine cell fluid by the operation medium supply branch. Chinese herbal medicine powder is the Chinese herbal medicine powder made using the method. Chinese herbal medicine cell fluid is the Chinese herbal medicine cell fluid prepared using the method.

(37) A preparation method of ginseng powder and ginseng cell fluid and a product processed by same. The method includes: washing fresh ginseng and adding it to the fourth configured circulating mill, discharging ginseng powder from a main discharge port, and collecting ginseng cell fluid by the operation medium supply branch. Ginseng powder is made using the method. Ginseng cell fluid is the ginseng cell fluid prepared using the method.

The same method can also be used to prepare the following fresh Chinese herbal medicine powder and cell fluid thereof, radix linderae, atractylodes, radix paeoniae alba, fritillaria, hyacinth bletilla, American ginseng, red ginseng, Chinese yam, chrysanthemum morifolium ramat, rhizoma corydalis, radix scrophulariae, radix ophiopogonis, radix curcumae, notoginseng, pine needles, pear, notoginseng flower, notoginseng leaf, gastrodia elata, erigeron breviscapus, caulis dendrobii, radix angelicae sinensis, magnolia officinalis, radix scutellariae, amomum villosum, polygonum multiflorum, resina draconis, radix aconiti brachypodi, common alstonia leaf, kusnezoff monkshood root, pinellia, radix geutianae, eucommia, radix saposhnikoviae, poria cocos, honeysuckle, rhizoma polygonati, cordyceps sinensis, radix bupleuri, radix codonopsis, pepper, radix isatidis, aloe vera, amomum, rhizoma paridis, rhizoma ligustici wallichii, cordate houttuynia, loquat leaf, croton, gallnut, cornus, radix dipsaci, rhodiola, sea buckthorn powder, desertliving cistanche, astragalus, licorice, Chinese wolfberry, spikenard, valerian, red paeony root, notopterygium, selfheal, radix angelicae pubescentis, lily, radix polygonati officinalis, gynostemma, Chinese bulbul, cowherb seed, fruit of Chinese magnoliavine, dodder, hawthorn, artemisinin, cortex periplocae, moringa leaf, rhizoma zedoariae, gardenia, folium artemisiae argyi, cinnamon, ageratum, fructus anisi stellati, ganoderma lucidum, ganoderma lucidum spore, wild fungus, mushrooms, stevia, rhizoma acori tatarinowii, radix puerariae, radix pseudostellariae, phytolacca acinosa, polygonum cuspidatum, rhubarb, paniculate swallowwort root, motherwort, sophora, chrysanthemum, gordon euryale seed, tribulus terrestris, rhizoma bistortae, rhizoma drynariae, herba artemisiae scopariae, fructus arctii, forsythia, herba schizonepetae, uncaria, daphne genkwa, mint, coix seed, fructus xanthii, rhizoma arisaematis, radix fici hirtae, sargentodoxa cuneata, lysimachia christinae hance, raspberry, dogbane leaf, radix ranunculi ternati, semen cassiae, platycodon grandiflorum, papaya, radix sanguisorbae, fructus gleditsiae sinensis, antipyretic dichroa, cirsium japonicum, radix aconiti carmichaeli, radix peucedani, acanthopanax, rhizoma anemarrhenae, lycium ruthenicum, rhizoma alismatis, saffron, cardamom, matsutake, osmanthus fragrans, saussurea involucrata, folium mori, eurycoma longifolia, and the like.

(38) A preparation method of gecko powder and a product processed by same. The method includes: washing fresh geckos and adding them to the fourth configured circulating mill to make dry powder. Gecko powder is processed using the method. The same method can also be used to prepare following animal powder: cuttlefish bone, leech, bezoar, deer antler, bear bile, ground beeltle, cantharidopsis powder, cicada slough, ant, centipede, pearl, black chicken, pig blood, eel, cubilose, crab shell, and the like.

(39) A preparation method of medicinal talc powder. The method includes: adding talc powder raw material to the fourth configured circulating mill to make dry powder. Medicinal talc powder is the talc powder processed using the method.

The same method can also be used to prepare medicinal mirabilite powder, medicinal gypsum powder, and the like.

(40) A preparation method of seaweed powder and a product processed by same. The method includes: draining fresh seaweeds and adding them to the fourth configured circulating mill to make dry powder. Seaweed powder is the seaweed powder processed using the method.

(41) A preparation method of fragmented spirulina powder and a product processed by same. The method includes: adding fresh spirulina to the fourth configured circulating mill to make fragmented spirulina powder. Fragmented spirulina powder is the fragmented spirulina powder processed using the method.

(42) A preparation method of putty for construction and a product processed by same. The method includes: adding raw putty materials for construction to the sixth configured circulating mill to make powder. Putty for construction is the putty for construction processed using the method.

(43) A grinding method for cement clinker and a product processed by same. The method includes: operating the sixth configured circulating mill to add cement clinker to equipment through a feeding port of the mill, pre-crushing, by the mill, the materials into coarse powder, and driving, by an air flow in an outer circulation pipe, the coarse powder into the circulating mill main engine to further crush it into fine powder which is separated by the bag dust collector to obtain cement powder. Cement is the cement processed using the method.

The same method can also be used to prepare titanium dioxide, calcium carbonate, lithopone, kaolin powder, coal powder, stone powder, ore powder, gypsum powder, feldspar powder, graphite powder, silica powder, and the like.

(44) A grinding method of iron powder and a product processed by same. The method includes: pre-fabricating iron powder raw materials into small pieces below 5 mm and adding them to the circulating mill to make fine powder. Iron powder is the iron powder processed using the method.

The same method can also be used to process tungsten powder, copper powder, cobalt powder, nickel powder, titanium powder, tantalum powder, aluminum powder, tin powder, lead powder, and other metal powder.

(45) A grinding method of pesticide powder and a product processed by same. The method includes: adding pesticide raw materials to the fourth configured circulating mill to make fine powder. Pesticide powder is the pesticide powder processed using the method.

(46) A method of sea water desalinization and a product processed by same. The method includes: adding sea water to the second configured circulating mill for spray drying, and condensing, by the operation medium supply branch, vaporized moisture into liquid water to obtain fresh water. Fresh water is the fresh water processed using the method.

(48) A method of drying sludge. The method includes adding sludge into the fifth configured circulating mill to make dry powder. Sludge is the sludge processed using the method.

The method can also be used to process sewage sludge, septic tank sludge, farm manure, kitchen waste, tailings discharged from water treatment equipment, vegetable waste, and other high-humidity and high-viscosity materials.

(49) A method of processing edible and medicinal powder and retrieving cell fluid and a product processed by same. The method includes: washing edible and medicinal raw materials and adding them to the fourth configured circulating mill to make powder, obtaining the powder discharged from a main discharge port, and condensing, by the operation medium supply branch, gaseous water and gaseous volatile components generated during processing into liquid to obtain cell fluid. Edible and medicinal powder is processed using the method. Cell fluid is the cell fluid prepared using the method.

(50) A preparation method of banana powder and banana powder. The method includes making edible parts of bananas into banana powder by using the fourth configured circulating mill. Banana powder is the banana powder processed using the method.

(51) A preparation method of green banana powder and green banana powder. The method includes: controlling the oxygen content in the operation medium to be less than 5% by mass, and making peeled or unpeeled green bananas into green banana powder by using the fourth configured circulating mill. Green Banana powder is the banana powder processed using the method.

(52) A fragmentation method for washed pine pollen and washed fragmented pine pollen. The method includes centrifugally dehydrating washed pine pollen with water content of 65% to 75% into fragmented powder by using the fourth configured circulating mill. Washed fragmented pine pollen is the washed fragmented pine pollen processed using the method.

(53) A drying method for juice prepared by pressing and a product processed by same. The method is performed according to following steps: S1: equipment configuration: selecting the second configured circulating mill, and selecting nitrogen with oxygen content less than 6% as the operation medium; and S2: adding the juice prepared by pressing to the equipment configured in S1 to make powder, and obtaining the powder discharged from a maim discharge port. Powder processed from juice prepared by pressing is the powder processed using the method.

(54) A preparation method of barley green and a product processed by same. The method is performed according to following steps: S1: equipment configuration: selecting the second configured circulating mill, and controlling the oxygen content of the operation medium to be less than 5%; S2: preparing barley grass juice: S201: treatment of raw materials: rinsing tender barley grass; S202: juicing: juicing the barley grass prepared in S201 to obtain barley grass juice; S203: filtering: filtering solid substances in the barley grass juice prepared in S202 to obtain fine barley grass juice; and S3: spray drying: adding the fine barley grass juice prepared in S2 to the equipment configured in S1 for spray drying, and obtaining barley green discharged from a main discharge port. Barley green is the barley green processed using the method.

(55) A preparation method of soluble notoginseng powder and soluble notoginseng powder. The method includes making fresh notoginseng juice prepared by pressing into soluble notoginseng powder by using the second configured circulating mill. Soluble notoginseng powder is the soluble notoginseng powder processed using the method.

The same method can also be used to prepare soluble maca powder, soluble apple powder, soluble emblic leafflower fruit powder, soluble matsutake powder, and the like.

(56) A fragmentation method of pine pollen and a product processed by same. The method is performed according to following steps: S1: configuring equipment: S101: employing the fourth circulating mill and the second circulating mill main engine, and configuring the accessory device with the fourth operation medium supply branch, S102: configuring the accessory device with the second feeding device and the second return device, S103: configuring the third or fourth optical device, and selecting an ultraviolet sterilization light source as the light source of the optical device, S104: setting the switching valve of the fourth operation medium supply branch to make the compressor exhaust pipe connected to the second branch and disconnected from the first branch, and opening the valve on the pipeline between the air duct and the outlet of the heater, S105: selecting nitrogen with oxygen content less than 10% as the operation medium; and S2: fragmentation of pine pollen: adding pine pollen to the equipment configured in S1 to make fragmented pine pollen. Fragmented pine pollen is the fragmented pine pollen processed using the method.

The operation medium of the equipment used by the method is cold air, which solves the problem that the heat into which the kinetic energy of the main engine is converted increases the temperature in the machine. Due to the setting of the ultraviolet sterilization device, processed materials and incoming materials can be processed at the same time.

(52) The operation medium for equipment used by the fragmentation method for washed pine pollen and the washed fragmented pine pollen is hot air. Due to the high moisture content of the materials, the water vaporization consumes the heat in the hot air and the heat into which the kinetic energy of the main engine is converted. Under appropriate working conditions, the temperature in the machine can be maintained at normal temperature.

(57) A preparation method of ultrafine powder of Chinese herbal medicines and ultrafine powder of Chinese herbal medicines. The method includes: making dry Chinese herbal medicines into ultrafine powder by using the equipment configured in step S1 in the fragmentation method of pine pollen and the product processed by same in (56). Ultrafine powder of Chinese herbal medicines is the ultrafine powder of Chinese herbal medicines processed using the method.

In the present invention, the terms such as “first,” “second,” and “third” and so on are merely for the purpose of description, but cannot be understood as indicating or implying relative importance. The term “multiple” means two or more unless otherwise explicitly defined. The terms “mount,” “connect with,” “connect,” “fix,” and the like shall be understood in a broad sense. For example, “connect” may mean being fixedly connected, detachably connected, or integrally connected; and “connect with” may mean being directly connected or indirectly connected through an intermediary. For those of ordinary skill in the art, specific meanings of the above terms in the present invention can be understood according to specific situations.

In the description of the present invention, it should be understood that if orientation or position relations indicated by the terms such as “upper,” “lower,” “left,” “right,” “front,” “back,” and the like are based on the orientation or position relations shown in the drawings, and the terms are intended only to facilitate the description of the present invention and simplify the description, rather than indicating or implying that the apparatus or element referred to must have a particular orientation and be constructed and operated in the particular orientation, and therefore cannot be construed as a limitation on the present invention.

The above are merely preferred embodiments of the present invention and are not intended to limit the present invention. The present invention may be subject to changes and variations for those skilled in the art. Any modifications, equivalent replacements, and improvements made within the spirit and principles of the present invention shall all be encompassed in the protection scope of the present invention.

What is claimed is:

1. A circulating mill main engine, comprising: a primary mill, a secondary mill, a first inner circulation pipe, and a second inner circulation pipe; the primary mill and the secondary mill are a circulating mill, the circulating mill is improved by a centrifugal fan, which is composed of a housing, an impeller, and a feed pipe, the casing and the impeller constitute the structure of the centrifugal fan, the feed pipe is provided with an inner circulation pipe interface, one end of the feed pipe is connected to an air inlet on the housing, the other end of the feed pipe is an inlet of the circulating mill, an air outlet on the housing is an outlet of circulating mill; an outlet of the primary mill is connected to the first inner circulation pipe interface of the secondary mill through the inner circulation pipe, an outlet of the secondary mill is connected to the second inner circulation pipe interface of the primary mill through the inner circulation pipe, an inlet of the primary mill is an inlet of the circulating mill main engine, and an inlet of the secondary mill is an outlet of the circulating mill main engine.
[a third circulating mill main engine]

2. The circulating mill main engine according to claim 1, wherein the circulating mill main engine further comprises a kinetic energy recovery device, the kinetic energy recovery device comprises a transmission and a kinetic energy recovery impeller, the kinetic energy recovery impeller is fixed to an input shaft of the transmission, an output shaft of the transmission is the impeller shaft of the centrifugal fan, the kinetic energy recovery device is disposed in the feed pipe of the secondary mill, and an air flow from a inner circulation pipe interface on the feed pipe assists in driving the centrifugal fan impeller to rotate; and/or, the kinetic energy recovery device is disposed in the feed pipe of the primary mill, and an air flow from a inner circulation pipe interface on the feed pipe assists in driving the centrifugal fan impeller to rotate.
[a second circulating mill main engine]

3. The circulating mill main engine according to claim 1, wherein the housing of the primary mill is provided with 2 or 3 or 4 outlets, and the number of the secondary mill and the number of the inner circulation pipe interface on the feed pipe of the primary mill are the same as the number of the outlet on the housing of the primary mill.
[a Seven circulating mill main engine]

4. The circulating mill main engine according to claim 2, wherein the housing of the primary mill is provided with 2 or 3 or 4 outlets, and the number of the secondary mill and the number of the inner circulation pipe interface on the feed pipe of the primary mill are the same as the number of the outlet on the housing of the primary mill.
[a Seven circulating mill main engine]

5. The circulating mill main engine according to claim 1, wherein the feed pipe of the secondary mill is a cyclone dust collector, of which an air inlet is an inner circulation pipe interface, an ash discharge port is connected to an air inlet on the housing, and an exhaust outlet is an inlet of the circulating mill the air inlet of the cyclone dust collector is the internal circulation pipe interface; and/or, the feed pipe of the primary mill is a cyclone dust collector, of which an air inlet is an inner circulation pipe interface, an ash discharge port is connected to an air inlet on the housing, and an exhaust outlet is an inlet of the circulating mill the air inlet of the cyclone dust collector is the internal circulation pipe interface.

6. The circulating mill main engine according to claim 2, wherein the feed pipe of the secondary mill is a cyclone dust collector, of which an air inlet is an inner circulation pipe interface, an ash discharge port is connected to an air inlet on the housing, and an exhaust outlet is an inlet of the circulating mill the air inlet of the cyclone dust collector is the internal circulation pipe interface; and/or, the feed pipe of the primary mill is a cyclone dust collector, of which an air inlet is an inner circulation pipe interface, an ash discharge port is connected to an air inlet on the housing, and an exhaust outlet is an inlet of the circulating mill the air inlet of the cyclone dust collector is the internal circulation pipe interface.

7. A circulating mill, comprising the circulating mill main engine according to claim 1 and an accessory device, the accessory device comprises a dust collector and an outer circulation pipe, an air inlet of the dust collector is connected to the outlet of the circulating mill main engine, and an outlet of the outer circulation pipe is connected to the inlet of the circulating mill main engine.

8. The circulating mill according to claim 7, wherein the accessory device comprises a cyclone dust collector, a bag dust collector, and an outer circulation pipe, the outer circulation pipe is provided with a cyclone dust collector ash discharge interface, an air inlet of the cyclone dust collector is connected to the outlet of the circulating mill main engine, a cyclone dust collector exhaust outlet is connected to an air inlet of the bag dust collector, a cyclone dust collector ash discharge port is connected to the cyclone dust collector ash discharge interface on the outer circulation pipe, and an outlet of the outer circulation pipe is connected to the inlet of the circulating mill main engine.

9. The circulating mill according to claim 7, wherein the circulating mill main engine is the circulating mill main engine according to claim 2.

10. The circulating mill according to claim 7, wherein the circulating mill main engine is the circulating mill main engine according to claim 4.

11. The circulating mill according to claim 8, wherein the accessory device further comprises an operation medium supply branch, the operation medium supply branch comprises a heat exchanger, a condenser, and a heater, the heat exchanger comprises a heat exchange branch and a cooling branch, heat medium channel air inlets of the heat exchange branch and the cooling branch are gathered together through a heat exchanger air inlet pipe, an inlet of the heat exchanger air inlet pipe is an air inlet of the operation medium supply branch, heat medium channel exhaust outlets of the heat exchange branch and the cooling branch are connected to an air inlet of the condenser, an exhaust outlet of the condenser is connected to an inlet of a refrigerant channel of the heat exchange branch through a condenser exhaust pipe, an exhaust outlet of the refrigerant channel of the heat exchange branch is connected to an air inlet of the heater through a refrigerant channel exhaust pipe, an exhaust outlet of the heater is the exhaust outlet of the operation medium supply branch, the air inlet of the operation medium supply branch is connected to an exhaust outlet of the bag dust collector, and the exhaust outlet of the operation medium supply branch is connected to an air inlet of the outer circulation pipe.

12. The circulating mill according to claim 8, wherein the accessory device further comprises an operation medium supply branch, the operation medium supply branch comprises, the operation medium supply branch comprises a first heat exchanger, a second heat exchanger, a condenser, and a heater, a heat medium channel inlet of the first heat exchanger is an air inlet of the operation medium supply branch, an outlet of the heater is the exhaust outlet of the operation medium supply branch, an air flow channel of the operation medium supply branch is formed by a heat medium channel of the first heat exchanger, a heat medium channel of the second heat exchanger, a heat medium channel of the condenser, an air duct, a refrigerant channel of the second heat exchanger, and a refrigerant channel of the heater connected sequentially, a refrigerant channel of the condenser is an evaporator of a heat pump, a heat medium channel of the heater is a condenser of the heat pump, and the air inlet of the operation medium supply branch is connected to an exhaust outlet of the bag dust collector, and the exhaust outlet of the operation medium supply branch is connected to an air inlet of the outer circulation pipe.

13. The circulating mill according to claim 9, wherein the accessory device further comprises a mill disposed on the outer circulation pipe.

14. The circulating mill according to claim 8, wherein the circulating mill is provided with an optical device comprising a tee joint, a light source, a reflector, and a dust-proof fan, an opening of the tee joint is connected to the outlet of the circulating mill main engine, a second opening is connected to an air inlet of a cyclone dust collector, the light source is disposed in a third opening of the tee joint, the third opening of the tee joint is connected to an exhaust outlet of the dust-proof fan, an inlet of the dust-proof fan is in communication with an air purification chamber of a bag dust collector, and the reflector is configured to concentrate light on fluidized materials.

15. The circulating mill according to claim 8, wherein the accessory device further comprises a return device composed of a 1# conveyor and a 2# conveyor, the 1# conveyor is provided with one feed port and two discharge ports, one discharge port is a main discharge port of the circulating mill, the 2# conveyor is provided with two feed ports and two discharge ports, the feed port of the 1# conveyor is connected to an ash discharge port of the bag dust collector, the other discharge port of the 1# conveyor is connected to one feed port of the 2# conveyor, the other feed port of the 2# conveyor is connected to the cyclone dust collector ash discharge port, one discharge port of the 2# conveyor is provided with a valve, an outlet of the valve is connected to the cyclone dust collector ash discharge interface on the outer circulation pipe, and the other discharge port of the 2# conveyor is an auxiliary discharge port of the circulating mill.

16. The circulating mill according to claim 7, wherein the accessory device further comprises a feeding device disposed on the outer circulation pipe, and the feeding device is a feeder and/or an atomizer.

17. A circulating mill main engine, comprising: a housing, an impeller, a inner circulation pipe, a feed pipe, and a three-way air inlet, the casing and the impeller constitute the structure of a centrifugal fan, the feed pipe is provided with an inner circulation pipe interface, an outlet on the housing is connected to an inner circulation pipe interface on the feed pipe through an inner circulation pipe, a three-way air inlet is disposed between one end of the feed pipe and the air inlet on the housing, a second opening of the three-way air inlet is an inlet of the circulating mill main engine, and the other end of the feed pipe is an outlet of the circulating mill main engine.
[a fifth circulating mill main]

18. The circulating mill main engine according to claim 17, wherein the circulating mill main engine further comprises a kinetic energy recovery device, the kinetic energy recovery device comprises a transmission and a kinetic energy recovery impeller, the kinetic energy recovery impeller is fixed to an input shaft of the transmission, an output shaft of the transmission is the impeller shaft of the centrifugal fan, the kinetic energy recovery device is disposed in the feed pipe, and an air flow from a inner circulation pipe interface on the feed pipe assists in driving the centrifugal fan impeller to rotate.
[a fourth circulating mill]

19. An application method of a circulating mill, wherein materials are dried and/or pulverized by using the circulating mill according to claim 10.

20. A product processed by a circulating mill, wherein the product is a powder processed by using a circulating mill according to claim 7.
